(19) United States
(12) Patent Application Publication
(10) Pub. No.: US 2015/0220487 A1
(43) Pub. Date: Aug. 6, 2015

(54) Method and Apparatus for Analysing Data Representing Attributes of Physical Entities

(71) Applicant: Towers Perrin Capital Corp., Wilmington, DE (US)

(72) Inventor: Tony Lovick, Cambridge (GB)

(21) Appl. No.: 14/537,254

(22) Filed: Nov. 10, 2014

Related U.S. Application Data
(63) Continuation of application No. 13/468,838, filed on May 10, 2012, now abandoned.
Application No. 13/468,838 is a continuation of application No. PCT/GB2011/052296, filed on Nov. 23, 2011.

(51) Int. Cl. G06F 17/18; G06F 17/50

(52) U.S. Cl. CPC G06F 17/18; G06F 17/5009

(57) ABSTRACT

Analysis of electronic data which comprises, for each of a set of physical entities, attribute values representing attributes of the respective physical entity and an outcome value representing an observed outcome for the entity which may be used to generate a model for predicting the outcome value for another physical entity of the same type. The data is processed using a statistical modelling method to generate a model based on the data. The method then involves calculating a case deleted estimate of the outcome value for each of the set of physical entities using the processor; calculating a measure of the deviance of the case deleted estimates from the actual outcome values in the input data; and outputting the calculated deviance measure to the data storage for retrieval by a user.

### CROSS REFERENCE TO RELATED APPLICATIONS

This application is a continuation of U.S. patent application Ser. No. 13/468,838, filed May 10, 2012, which is a continuation under 35 U.S.C. §120 of International Application No. PCT/GB2011/052296, filed Nov. 23, 2011, and claims priority under 35 U.S.C. §119(a) to Great Britain Application No. 1020091.3, filed Nov. 26, 2010, the entire content of each of which is hereby fully incorporated herein by reference.

### FIELD OF THE INVENTION

The present invention relates to analysis of electronic data which comprises, for each of a set of physical entities, attribute values representing attributes of the respective physical entity and an outcome value representing an observed outcome for the respective physical entity. Such analysis is widely used to generate a model for predicting the outcome value (that is, the most likely outcome or value of a chosen metric) for another physical entity of the same type.

### BACKGROUND OF THE INVENTION

1.1 Current Statistical Techniques

1.1.1 Current modelling techniques use the generalised linear modelling framework to estimate parameters (that is, coefficients) for a given model structure based upon calculating the minimum deviance (maximum likelihood) estimates for the parameters from a given dataset.

1.1.2 First the structure of the model to be produced (both appropriate link function and distribution) is established using an understanding of the data, and then considering residual plots and the results of the Tweedie distribution test (Box-Cox transformation).

1.1.3 The significance of parameter estimates can then be judged according to the standard errors calculated from the information matrix, and various statistical tests for example the Chi Squared and F-Tests can be used to compare two competing models.

1.1.4 A range of other statistics such as the Akaike Information Criteria “AIC”, and Bayesian Information Criteria “BIC” can also be considered.

These statistical approaches were originally utilised in the context of relative few factors and levels and relatively few interactions. The range of factors, number of levels within factors and the number of interactions has increased significantly in UK personal lines insurance as insurers have sought competitive advantage and more recently to prevent anti-selection on price comparison sites (“Winner's Curse”).

1.2 Short-comings of Statistical Techniques

1.2.1 As discussed, over time the size of modelling datasets has increased (datasets up to 100 m rows are becoming more common), and this has highlighted the differences between academic methods designed for a few thousand rows and actual insurance specific models deployed to determine prices.

1.2.2 In particular the Degrees of Freedom are defined by the number of rows of data—number of parameters (unaliased). This becomes effectively constant where the dataset is large, and the parameter list rarely exceeds 1000.

1.2.3 The Deviance for a model decreases as new parameters are added. Hence the ratio of residual deviance to number of degrees of freedom always improves when the degrees of freedom is effectively constant. This causes Chi Squared tests on nested models and F-Tests to accept parameters which would be rejected from a business perspective as spurious and over-parameterised.

1.2.4 The likelihood of overfitting clearly increases the more parameters that are added to the model, be it factors, levels or interactions.

1.3 Current Business Techniques

1.3.1 There is wide recognition that modelling is not a pure science and better results can be achieved using domain knowledge (by applying some “art”). The statistical techniques are usually supported by checking the models against business understanding of the factors, their usual significance and trends from past time periods and other datasets.

1.3.2 Time consistency testing is used to ensure that a factor shape is both consistently present for given time periods, and to establish if there is trend for the shape to strengthen, weaken or change shape over time. This is essential if the chosen values of the parameters are to be predictive for a future time period, which is normally the business objective.

1.3.3 To mitigate the problems outlined in 1.2, extensive use is also often made of hold-out sample data. This is where a model is built on a sample of the data, say 80% (modelling or training data) and then the performance is judged by comparing results scored against the remaining 20% (hold-out sample). This approach often, though, only provides apparent comfort as it is not clear what a good or bad “fit” looks like when judged on the hold-out sample. An in-time hold-out sample will have the same mix of business and most adequate models will look to fit well when applied to a hold-out sample. Also when you detect a poor “fit” it will not necessarily be clear how to correct for any overfitting.

1.3.4 There is also the problem of the range of observations that any modelling data contains, be it due to the underwriting footprint strategy or the particular channel business is distributed in. Underlying factor effects such as interactions may not be identified due to the lack of observed data. Here business knowledge is deployed, often in the form of underwriting overlays to statistical models before applying the models to the market.

1.4 Price Comparison Websites, Efficient Market, Winner's Curse

1.4.1 In recent years the rise of price comparison websites, particularly in the UK motor insurance market, has created a near perfect market for consumers. Coupled with the fact that many view motor insurance as a commodity product, this has resulted in observed new business elasticities ranging in magnitude from 10 to 100.

1.4.2 The estimates from a pricing model are best estimates in the statistical sense and hence are subject to uncertainty. In these circumstances the Winner's Curse operates as a powerful anti-selection effect which imposes a heavy penalty where the uncertainty randomly results in an estimate which is below the true value.

1.4.3 In this business context insurers have responded by increasing the range of factors, levels within factors and number of interactions as they have tried to minimise the level of anti-selection. But in doing so there is an increased likelihood of overfitting which does present a real business dilemma. When presented with a new factor to implement which makes sense from a business viewpoint and is significant, the view will, more often than not, be to introduce the factor. In fact it is very likely that when one systematically reviews the inclusion of each term in a sophisticated model that a business sense argument can be made for each and every one, but it is likely when taking together there will be an element of overfitting.

1.4.4 In addition to the parameter estimates, the modelling process makes available results which reveal the uncertainty attached to these expressed as a Variance/Covariance matrix. Also the Hat matrix which displays the influence that each data point has had on its corresponding estimate.

1.4.5 There are a number of elements which influence how this uncertainty varies from model to model, and by risk within the model. Two elements of this uncertainty are discussed below.

1.4.6 The first is the tendency for over-parameterised models to replicate noise within the data which will not be repeated in future observations. This noise is one source of estimate uncertainty.

1.4.7 The second is the tendency for models to be used over a heterogeneous domain. Some areas of the domain are well populated and hence estimates are subject to less uncertainty. The fringes of the domain which tend to be sparsely populated with observations resulting in greater levels of uncertainty. Extrapolation to future time periods is a special case of this which necessary for the deployment of most predictive models.

### SUMMARY OF THE INVENTION

The present invention provides a method for analysing input electronic data using an electronic processor, wherein the input data comprises, for each of a set of physical entities, attribute values representing attributes of the respective physical entity and an outcome value representing an observed outcome for the respective physical entity, the analysis generates a model for predicting the outcome value for a further physical entity on the basis of data comprising the attribute values associated with the further physical entity, and the method comprises the steps of:

(a) receiving the input data via an input of the processor and storing it in electronic data storage;

(b) retrieving the input data from the data storage and processing the input data with the processor using a statistical modelling method to generate a model based on the input data;

(c) calculating a case deleted estimate of the outcome value for each of the set of physical entities using the processor;

(d) calculating a measure of the deviance of the case deleted estimates from the actual outcome values in the input data; and

(e) outputting the calculated deviance measure to the data storage for retrieval by a user.

This measure may enable a user to refine a model in a more accurately predictive manner. The present methods provide an adjustment to the results which make them more predictive of future outcomes by providing insulation from noise in the input data.

The model may be used to predict an outcome value which may for example represent the likelihood of an event occurring in the case of the further physical entity. The model information may assist the management and planning of resources, for example.

The method may include a step after step (e) of:
calculating the number and location of knots to include in the model to minimise the deviance measure.

In a preferred implementation, the method includes the steps after step (e) of:
identifying at least one attribute to omit from the model on the basis of the associated deviance measure; and
removing that attribute from the model.

The invention further provides a method for analysing input electronic data using an electronic processor, wherein the input data comprises, for each of a set of physical entities, attribute values representing attributes of the respective physical entity and an outcome value representing an observed outcome for the respective physical entity, the analysis generates a model for predicting the outcome value for a further physical entity on the basis of data comprising the attribute values associated with the further physical entity, and the method comprises the steps of:

(a) receiving the input data via an input of the processor and storing it in electronic data storage;

(b) retrieving the input data from the data storage and processing the input data with the processor using a statistical modelling method to generate an intermediate model based on the input data, the intermediate model comprising parameter estimates and a variance/covariance matrix;

(c) calculating a case deleted estimate of the outcome value for each of the set of physical entities on the basis of the intermediate model using the processor; and

(d) generating a noise reduced model comprising noise reduced parameters, a noise reduced variance/covariance matrix, and noise reduced case deleted estimates using an iterative process so as to minimise a measure of the deviance of the noise reduced case deleted estimates from the actual outcome values in the input data.

Accordingly, the estimates produced by the intermediate model are adjusted to make them more predictive. The outputs of the intermediate model are tempered by penalising uncertain parameters to the extent that they are only rewarded for improving the likelihood (reducing Deviance) of the estimates as measured against hold-out sample data.

In a preferred embodiment of this method in step (d) the parameters βⱼ are replaced in the noise reduced model by noise reduced parameters β*ⱼ, with the noise reduced variances

$$Var ( {β}_{j}^{*} ) = {( \frac{{β}_{j}^{*}}{{β}_{j}} )}^{2} Var ( {β}_{j} ) ,$$

the noise reduced covariances

$$Cov ( {β}_{j}^{*} , {β}_{k}^{*} ) = ( \frac{{β}_{j}^{*}}{{β}_{j}} \frac{{β}_{k}^{*}}{{β}_{k}} ) Cov ( {β}_{j} , {β}_{k} ) ,$$

and the noise reduced case deleted linear predictors

$${η}_{( i )}^{*} = {η}_{i}^{*} - ( \frac{{h}_{i}^{*}}{1 - {h}_{i}^{*}} ) {g}^{′} ( {μ}_{i} ) ( {y}_{i} - {μ}_{i} ) where$$

$${h}_{i}^{*} = {\sum }_{jk} \frac{{X}_{ij} {β}_{j}^{*} {C}_{jk} {X}_{ik} {β}_{k}^{*} {W}_{i}}{{β}_{j} {β}_{k}} .$$

The method may include a step after step (e) of:
calculating the number and location of knots to include in the noise reduced model to minimise the deviance measure.

Furthermore, the method may include the steps after step (e) of:
identifying at least one attribute to omit from the noise reduced model on the basis of a measure of the deviance of the attribute relative to the noise reduced model; and
removing that attribute from the noise reduced model.

Calculation step (c) of the present methods preferably comprises calculating the case deleted estimate directly for each entity, without running the intermediate model for each entity on the basis of the input data with the data associated with that entity omitted.

Linear predictors and estimates are related by the link function in A.1.6, namely ηᵢ=g(μᵢ) The case deleted version is similar: η₍ᵢ₎=g(μ₍ᵢ₎).

For all the link functions there is a simple inverse function for g( ) so that if you calculate the linear predictor, you can then get the estimate. The log( ) link function is used in some examples, exp( ) being the inverse.

The preferred method involves calculating the case deleted linear predictors by adjusting the linear predictor provided by the intermediate model, by subtracting an amount equal to the influence on the model caused by the respective datapoint. This influence is described by the distance from the model to the datapoint (yᵢ−μᵢ), times the influence

$$( \frac{{h}_{i}}{1 - {h}_{i}} ) ,$$

times the rate of change of the linear predictor by the estimate,

$$\frac{\partial {η}_{i}}{\partial {μ}_{i}} = {g}^{′} ( {μ}_{i} ) .$$

Hence, calculation step (c) may comprise calculating case deleted linear predictors η₍ᵢ₎ such that:

$${η}_{( i )} = {η}_{i} - ( \frac{{h}_{i}}{1 - {h}_{i}} ) {g}^{′} ( {μ}_{i} ) ( {y}_{i} - {μ}_{i} ) where {h}_{i} = {\sum }_{jk} {X}_{ij} {C}_{jk} {X}_{ik} {W}_{i}$$

$$and \frac{\partial {η}_{i}}{\partial {μ}_{i}} = {g}^{′} ( {μ}_{i} ) .$$

In further implementations, as noted above, calculation step (c) may comprise calculating a case deleted estimate for each entity by running the intermediate model on the basis of the input data with the attribute values associated with that entity omitted to generate a respective set of case deleted model parameters.

The case deleted estimate may be calculated by taking the intermediate model (on the full dataset), extracting the one datapoint in question (or applying a zero weight to it's importance), and refitting. Given that the intermediate model is available as a starting point, this process only involves an iteration or two as described in A.1.10 below.

However, when there are many datapoints (possibly 100 million), even a single iteration here for each is laborious.

The preferred method is to calculate approximations of the case deleted linear predictors (as discussed above), and use the inverse link function to get a case deleted estimate without refitting the intermediate model. Computationally this is probably a million times (for example) more efficient than fitting the model 100 million times.

The statistical modelling method used to generate a model on the input data may generate a Generalised Linear Model or a Generalised Non-linear Model, for example.

The true mechanism for scaling back parameters described herein provides a further benefit. Simply allowing a model to become over-parameterised as it is developed, and reporting parameter errors which state they are not significant is not enough. With this method we can go further, and scale back the poor parameters effectively neutralising them from the model. Pruning processes may then operate to remove them altogether. This will allow the user to focus upon finding potential factors in the knowledge that unsuccessful attempts will not damage the output.

A company may choose to build the present modelling techniques on top of a market rates model, so that rather than scaling back towards the mean, parameters are scaled back towards market rates instead. Therefore a company would only differ from market structures where it had sufficient data to confirm a significant difference in experience.

### BRIEF DESCRIPTION OF THE DRAWINGS

Prior art techniques and embodiments of the invention will now be described by way of example and with reference to the accompanying drawings wherein:

FIG. 1 is a diagram illustrating the effect of case deletion;

FIG. 2 is a plot of standard error against parameter value for an accident damage frequency data set;

FIGS. 3 and 4 are plots representing the accuracy of case deleted estimates generated for a Log-Poisson and a Logit-Binomial model, respectively;

FIGS. 5 to 8 are plots of models generated for different factors for different knot positions;

FIG. 9 is a diagram illustrating case deletion;

FIG. 10 is a plot illustrating the decrease in value of a model over time;

FIGS. 11 to 17 show plots relating to models generated using methods embodying the present invention and sample data sets;

FIG. 18 illustrates an example embodiment of a method for analysing input data representing attributes of physical entities;

FIG. 19 illustrates another example embodiment of a method for analysing input data representing attributes of physical entities; and

FIG. 20 illustrates an example hardware circuit diagram of a general purpose computing device according to certain aspects described herein.

### DETAILED DESCRIPTION

2. Case Deletion

2.1 Elimination of Outliers by Case Deletion

2.1.1 Using a measure of residuals such as the Cook's Statistic, Outlier points can be excluded from the model based on their undue influence on the parameter estimates.

2.1.2 This technique is supported by leading statistical packages, but for datasets of the scale currently in use, deleting outliers is an onerous and unproductive task.

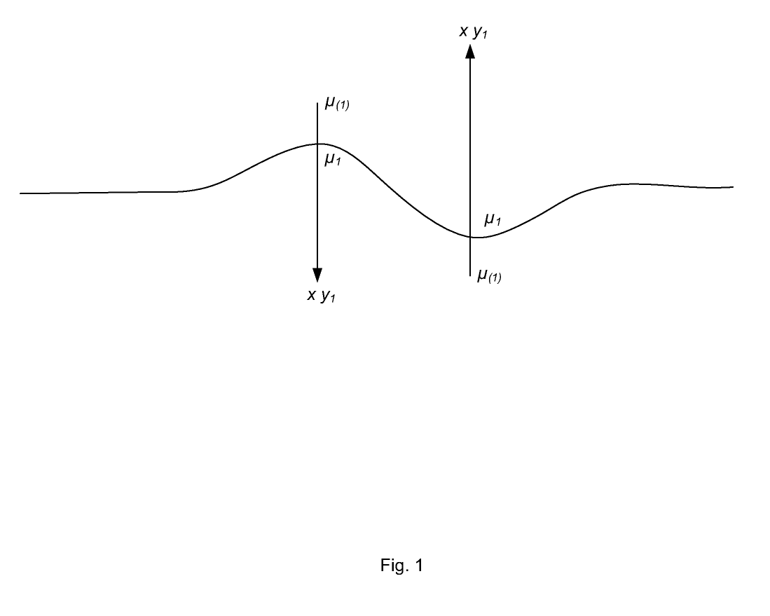

2.1.3 In essence each data point acts to pull the model towards itself, and the exclusion of that point and refitting the parameters will result in a new set of parameter values and hence new “Case Deleted” Estimate for that data point. By definition that estimate will lie further from the observed data point than the estimate produced by the full model. This is illustrated in FIG. 1, where yᵢ are the original datapoints, μᵢ are the estimates of those datapoints generated initially, and μ₍ᵢ₎ are the “Case Deleted” Estimates.

3. Calculation of “Case Deleted” Estimates

3.1 Formula for Case Deleted Parameters

3.1.1 McCullagh & Nelder suggest two methods for calculating “Case Deleted” parameters.

3.1.2 McCullagh & Nelder p396 discusses the idea of Case Deletion in the standard sense, as a means to identify whether to exclude individual outlier points from an analysis. They talk about the impact on the model fit of removing the point. Also that this is slow if the model needs to be refitted, and suggest that a first step approximation is used. For our purposes even if a single iteration was accurate enough a set of “Case Deleted” Parameters is still required for every data point which as noted in Berry would be impractically slow.

3.1.3 On p406 they quote a result from Atkinson for the linear case

$${\hat{β}}_{( j )} - {\hat{β}}_{j} = \frac{- {( {X}^{T} WX )}^{- 1} {x}_{i} ( {y}_{i} - {μ}_{i} )}{( 1 - {h}_{i} )}$$

where the Hat diagonal is defined as

hᵢ=diagᵢ(W^{1/2}X(X^{T}WX)⁻¹X^{T}W^{1/2})

and suggest a modification for the generalized linear case

$${\hat{β}}_{( j )} - {\hat{β}}_{j} = \frac{- {( {X}^{T} WX )}^{- 1} {x}_{i} ( {z}_{i} - {η}_{i} )}{( 1 - {h}_{i} )}$$

$$where$$

$${z}_{i} = g ( {y}_{i} )$$

3.1.4 For the linear case this can be used to generate the estimate directly

$${η}_{( i )} = {η}_{i} - ( \frac{{h}_{i}}{1 - {h}_{i}} ) \frac{( {y}_{i} - {μ}_{i} )}{{W}_{i}}$$

$$with the$$

$${h}_{i} = {\sum }_{jk} {X}_{ij} {C}_{jk} {X}_{ik} {W}_{i}$$

This formula and the one suggested in 3.1.3 have been found to be incorrect for the linear and generalised linear models, and a new one is proposed in section 5.2.3.

4. “Case Deleted” Deviance

4.1 Calculating of “Case Deleted” Deviance

4.1.1 Taking the “Case Deleted” Estimate provides a means to calculate a new “Case Deleted” Deviance. This is in effect the limiting case of calculating the deviance for a hold-out sample of one row against a model based on “n−1” rows, as the new estimate is not influenced by the observed value itself.

4.1.2 The Standard Deviance is a measure of the distance from the observed values to the estimate. In the extreme case where the model contains a parameter for every data point, the estimates and the observed values will be equal and the deviance will have a minimum value. The model here is replicating both the Pattern in the data and the Noise.

4.1.3 Because the “Case Deleted” Deviance is calculated from estimates which are independent of the observed values it represents the pattern but without the noise related to the observed data point in question. An extreme model will still include noise generated by the other data points, but provided the data points are independent this should average to zero.

4.1.4 A number of practical tests have been conducted comparing the Standard and “Case Deleted” Deviances. From these it is helpful to define some terms. Let SD₁, SD₂ be the Standard Deviances from a base model and an adjusted model. If the adjusted model is created by adding parameters to the base model, then we know that SD₁>SD₂. Similarly take CDD₁, CDD₂ to be the “Case Deleted” equivalents. Interestingly it is possible for CDD₂ to be larger than CDD₁ in circumstances where the extra parameters are adding more Noise to the model than Pattern.

4.1.5 Defining Pattern_{1,2}=CDD₁−CDD₂ and Noise_{1,2}=SD₁−SD₂−Pattern_{1.2}

The value of these measures is considered below and compared to existing tests.

4.2 Correlation with Standard Errors

4.2.1 The first example involved a Log-Poisson model with an Accident Damage Frequency dataset containing lm rows, with around 200 parameters covering a range of factors.

4.2.2 For each parameter in the model a new sub-model was created with that single parameter deleted. Then the Noise and Pattern measures were calculated between the full model and the sub-model.

4.2.3 Standard Errors over 50% are generally considered to be poor as these correspond to the parameter value of two standard errors, which equates to the 95% significance level of a normal distribution test.

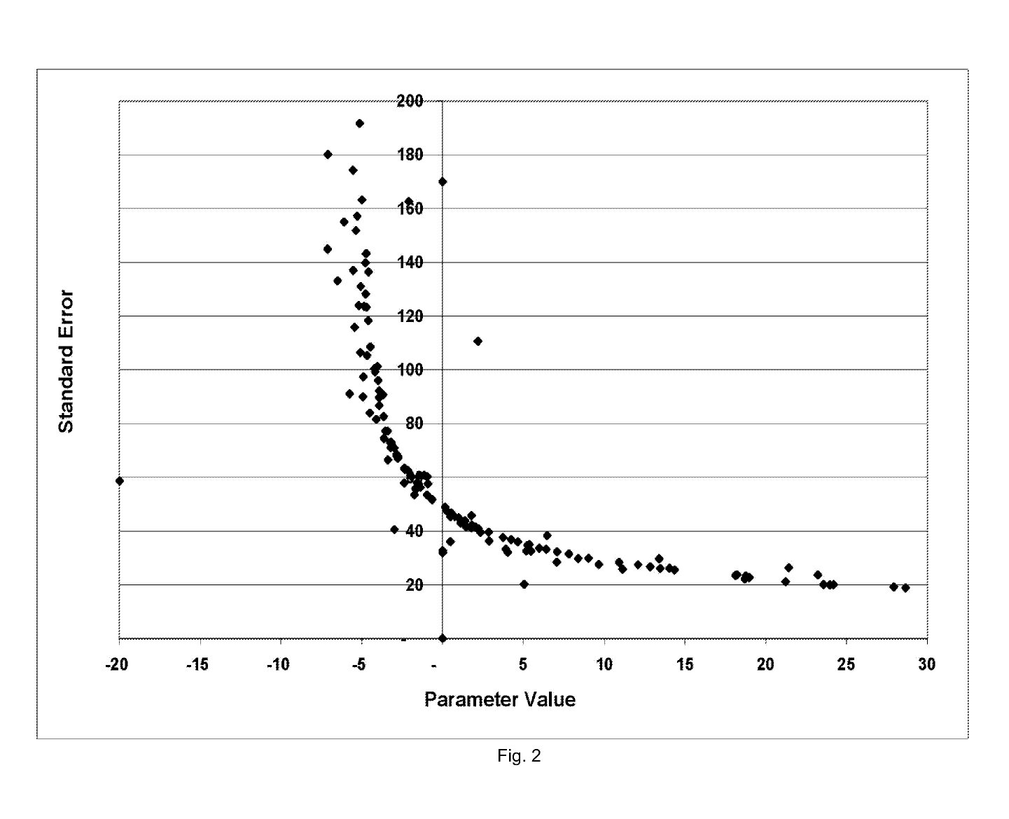

The two tests showed a strong correlation. Defining Value_{1,2}=Pattern_{1,2}−5*Noise_{1,2} shows a positive value when the Standard Error is less than 50% and negative above, as FIG. 2 demonstrates. While 5 appears a sensible value to choose in this example, adjustment may be required for other model structures and datasets.

5. Calculation of “Case Deleted” Estimates

5.1 Formula for Generalized Linear “Case Deleted” Estimates

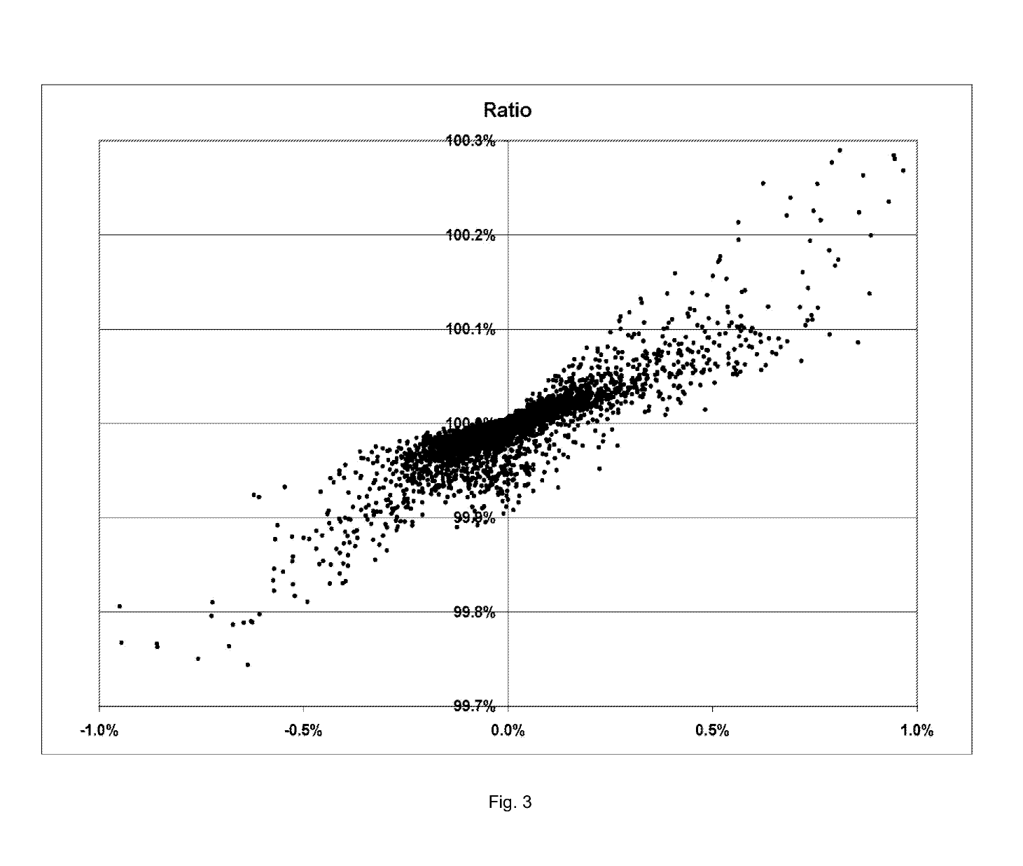

5.1.1 This same formula was also tested in the generalized linear case of a Log-Poisson model and found to be 99.8% accurate, albeit with a slight bias. FIG. 3 shows

$$- ( \frac{{h}_{i}}{1 - {h}_{i}} ) \frac{( {y}_{i} - {μ}_{i} )}{{W}_{i}}$$

on the x-axis and

$$( {η}_{( i )} - {η}_{i} ) / ( - ( \frac{{h}_{i}}{1 - {h}_{i}} ) \frac{( {y}_{i} - {μ}_{i} )}{{W}_{i}} )$$

on the y-axis where the actual η₍ᵢ₎ have been calculated with a full model fit per data point.

5.1.2 Likewise the second formula

$${\hat{β}}_{( j )} - {\hat{β}}_{j} = \frac{- {( {X}^{T} WX )}^{- 1} {x}_{i} ( {z}_{i} - {η}_{i} )}{( 1 - {h}_{i} )}$$

was also tested and rejected.

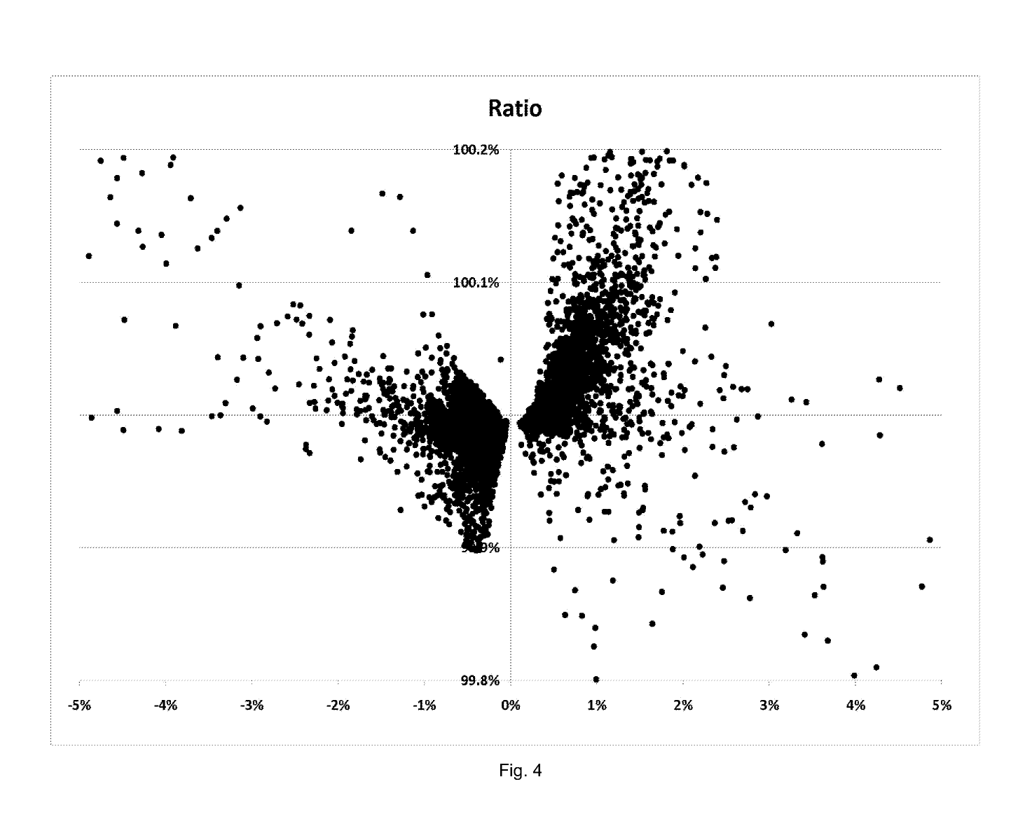

5.1.3 This method has also been checked on a Logit-Binomial model, giving the results shown in FIG. 4.

5.1.4 Armed with this new method we now have the ability to generate η₍ᵢ₎ directly from a single model fit.

5.2 Bayesian Understanding of the “Case Deleted” Estimates

5.2.1 The Hat matrix provides the influence of each data point on the parameters. The total of each row adding to one, and hence can be thought of as a credibility in a Bayesian context.

5.2.2 For a linear model the estimate will be formed as follows:

$${η}_{i} = {\sum }_{p} {h}_{p} {y}_{p} .$$

This can be rearranged as follows

$${η}_{i} = {h}_{i} {y}_{i} + {\sum }_{p \neq i} {h}_{p} {y}_{p}$$

then observing that η₍ᵢ₎ is the equivalent developed from one less data point

$${η}_{( i )} = \frac{{\sum }_{p \neq i} {h}_{p} {y}_{p}}{{\sum }_{p \neq i} {h}_{p}} = \frac{{\sum }_{p \neq i} {h}_{p} {y}_{p}}{( 1 - {h}_{i} )} , \\ {η}_{i} = {h}_{i} {y}_{i} + ( 1 - {h}_{i} ) {η}_{( i )}$$

$$so$$

$${η}_{( i )} = \frac{{η}_{i} - {h}_{i} {y}_{i}}{1 - {h}_{i}} = {η}_{i} - ( \frac{{h}_{i}}{1 - {h}_{i}} ) ( {y}_{i} - {η}_{i} )$$

5.2.3 For the Generalized Linear Model a first order approximation would be

$${η}_{( i )} = {η}_{i} - ( \frac{{h}_{i}}{1 - {h}_{i}} ) \frac{\partial {η}_{i}}{\partial {μ}_{i}} ( {y}_{i} - {μ}_{i} ) = {η}_{i} - ( \frac{{h}_{i}}{1 - {h}_{i}} ) {g}^{′} ( {μ}_{i} ) ( {y}_{i} - {μ}_{i} )$$

For Log-Poisson and Logit-Binomial models g′(μᵢ)V(μᵢ)=1, giving

$$3.1 .4 {η}_{( i )} = {η}_{i} - ( \frac{{h}_{i}}{1 - {h}_{i}} ) \frac{( {y}_{i} - {μ}_{i} )}{{W}_{i}}$$

for unit weights.

5.2.4 We undertook a numerical checking of a Log-Gamma model as for this structure

$${W}_{i} {g}^{′} ( {μ}_{i} ) = \frac{{ω}_{i}}{ϕ {μ}_{i}} .$$

For this model we found that

$${η}_{( i )} = {η}_{i} - ( \frac{{h}_{i}}{1 - {h}_{i}} ) {g}^{′} ( {μ}_{i} ) ( {y}_{i} - {μ}_{i} )$$

and hence reject 3.1.4.

6. Applications to Model Comparison

6.1 Optimal Knot Position Application for Factor Splines

6.1.1 This example is a case study using the same dataset as 4.2.1, and using the “Value” measure from 4.2.3 above.

6.1.2 For a number of factors Policyholder Age, Vehicle Group, Rating Area, NCD, Convictions, Number of Years Licence Held. Simple X-Values=Level Number were defined.

6.1.3 Then a knot was added to a spline defined with these X-Values, and then looping through each integer position for the knot, calculating the “Value” measure. The best position for the knot was selected and then the process repeated adding another knot. This was continued until an extra knot reduces “Value”.

6.1.4 This is not an efficient process since the smooth results obtained indicate the maximum “Value” position could be obtained with fewer steps. However the result graphs are more complete if every position is calculated for the result charts referred to below.

6.1.5 Once an extra knot has been added, this method did not recheck that the existing ones should remain in their current positions. An efficient implementation would first derive the number of knots required, then find their approximate positions, and finally jiggle them to find the global optimum.

6.1.6 Although the process of calculating the additional “Noise” was performed at each step, this turned out to be quite stable, hence the knot position could be estimated from the unadjusted deviance alone. The “Noise” adjustment is only needed to define the absolute “Value” of adding an extra knot.

6.1.7 Policyholder Age

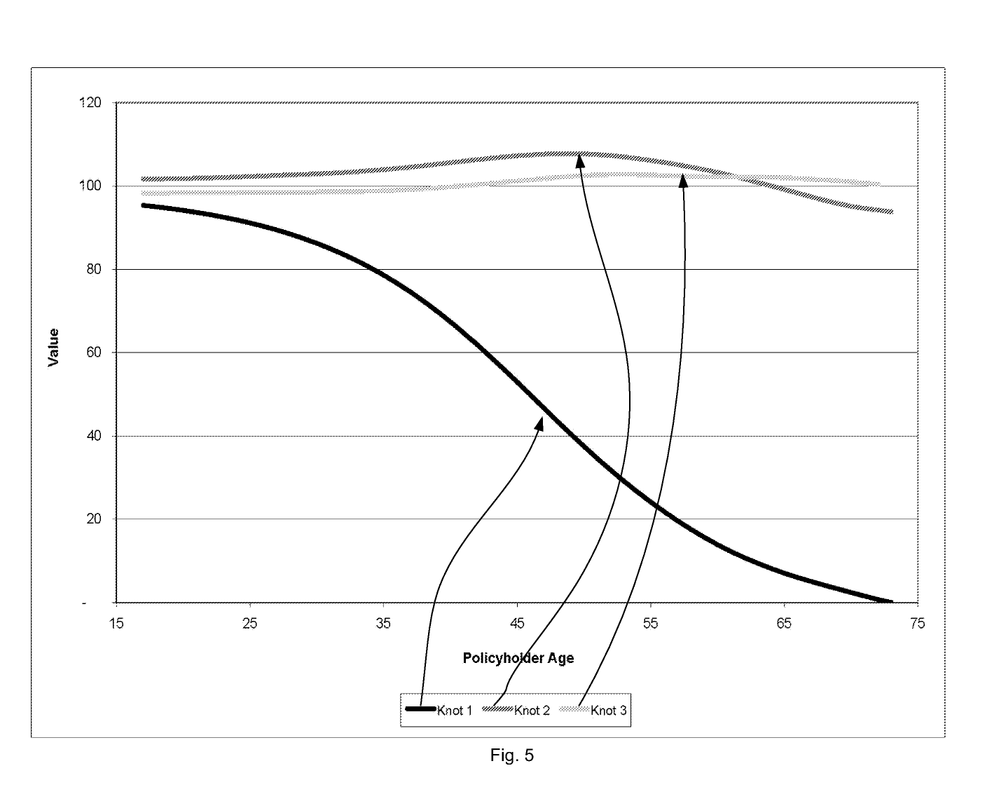

6.1.8 This factor suggests two knots at ages 17, 49, and rejects a third one at 53 (see FIG. 5).

6.1.9 Standard Error values would accept these two knots and reject the third, as would F-Tests

6.1.10 Vehicle Group

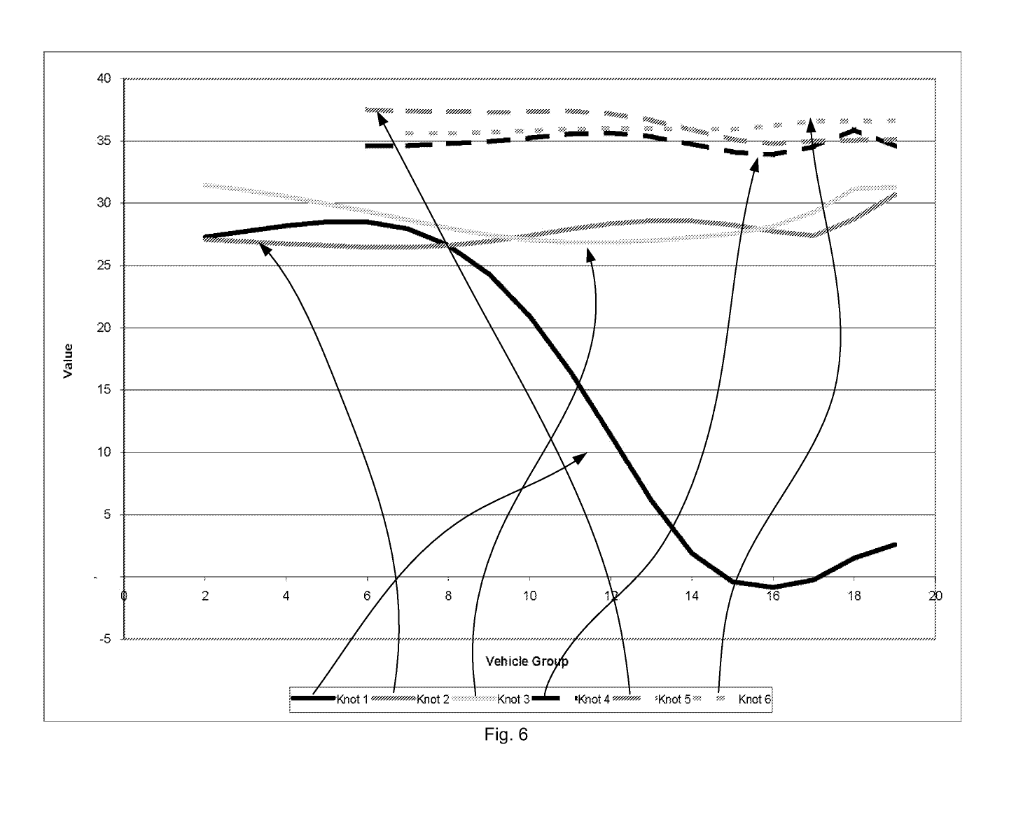

6.1.11 This factor suggests two knots at 5 and 19 (see FIG. 6).

6.1.12 The Standard Error test is confusing here, it would accept knot 5 from a spline containing (5, 19), would reject all parameters from splines (5,19, 2) and (5,19, 2, 18) and would accept knots 5, 2 from the five knot spline (5, 19, 2, 18, 6).

6.1.13 The F-Test considers the splines (5) similar to (5, 19), (5, 19, 2) and (5, 19, 2, 14), but claims the spline (5, 19, 2, 14, 6) is different from (5, 19, 2, 14) yet similar to (5, 19, 2).

6.1.14 Hence the “Value” measure appears useful as a global absolute statistic. The standard error only describes the certainty of an individual parameter, and becomes difficult when the SE values of several parameters vary from one model to the next. The F-Test only describes if two models are significantly different, not if one is better than the other.

6.1.15 Rating Area

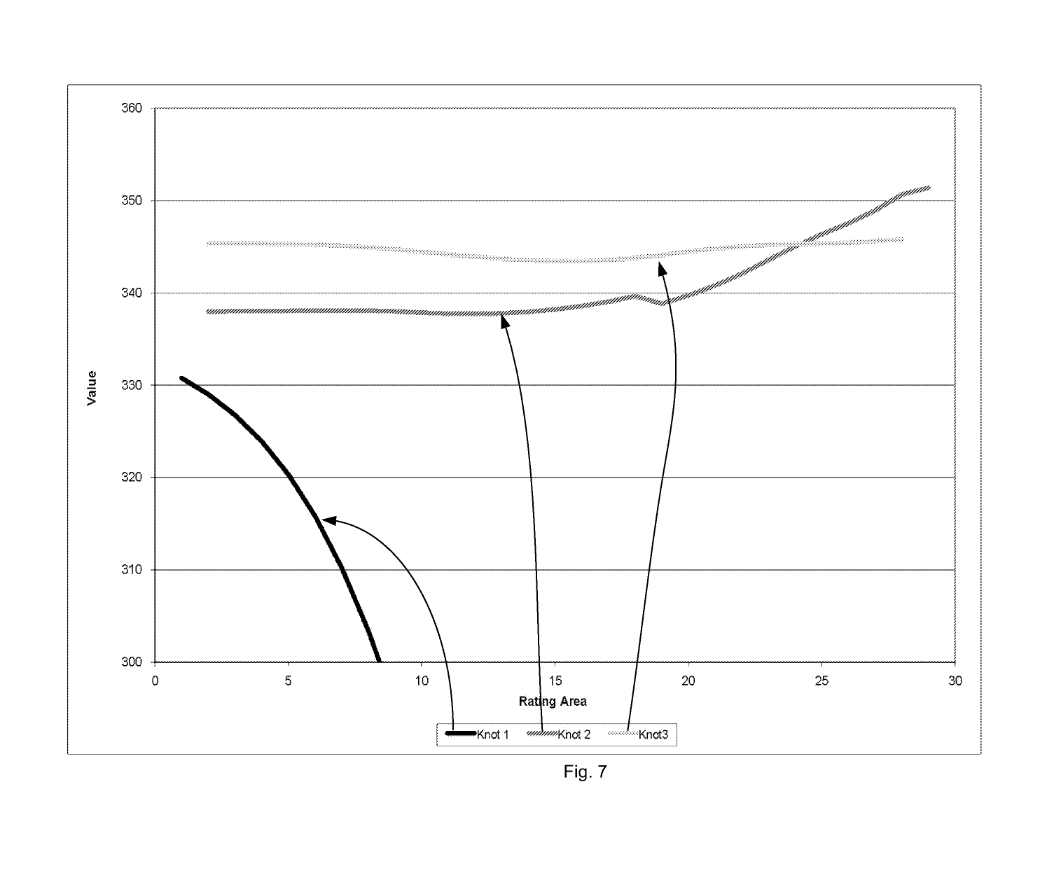

6.1.16 This factor gives two knots at 1 and 29 (see FIG. 7). In agreement with SE and F-Tests.

6.1.17 NCD

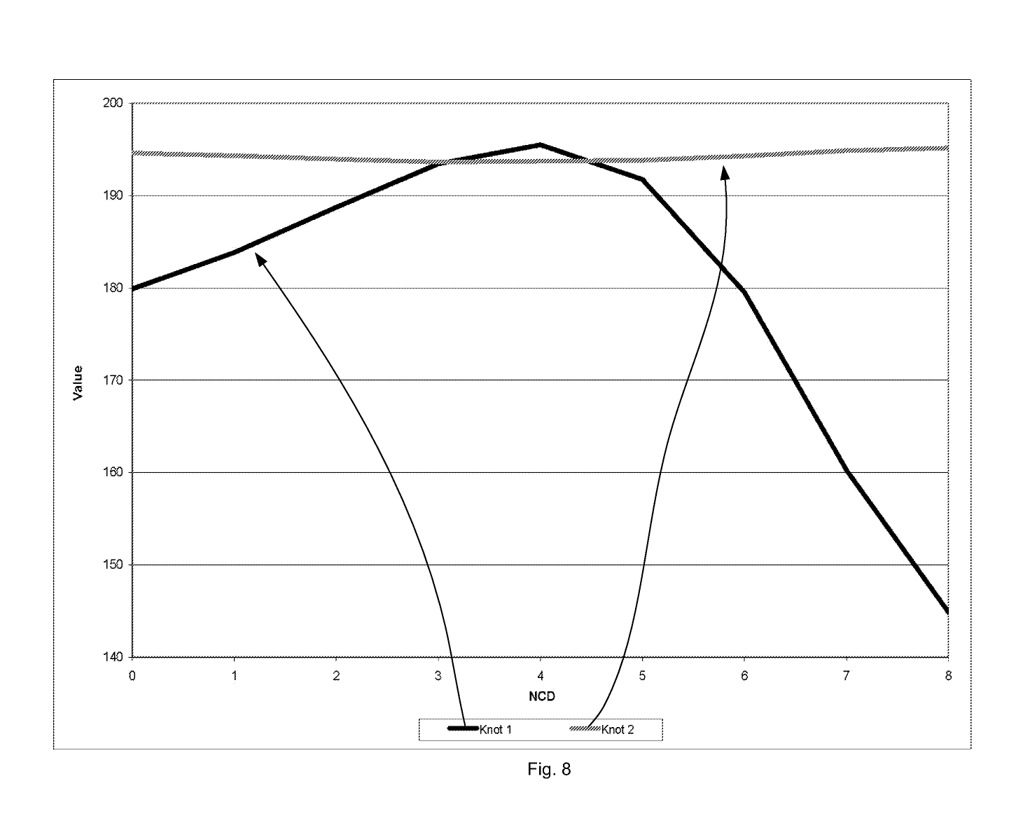

6.1.18 This factor gives one knot at 4 (see FIG. 8). In agreement with SE and F-Tests.

7. Noise Reduced Parameters

7.1 Desire for an amended set of parameters

7.1.1 The realisation that the “Case Deleted” Estimate μ₍ᵢ₎ is a useful noise independent measure, and readily calculated, led to a couple of initial attempts to use it directly to influence the model output estimates.

7.2 First and Second Attempts, Mean Adjustors

7.2.1 The first thought was that the noise in the model output could be reduced by artificially offsetting each data point to remove an equivalent amount, y*ᵢ=yᵢ+μ₍ᵢ₎−μᵢ. These can then be refitted to obtain a new set of estimates, μ*ᵢ.

7.2.2 The second attempt applied a second tier model to the “Case Deleted” Estimates from the first y*ᵢ=μ₍ᵢ₎ to try to produce some new estimates μ*ᵢ with less noise.

7.2.3 Neither of these produces results which are significantly different from the original estimates. This can be understood by reflecting on the way that GLM models select their parameters by placing them at the “mean” position of the sub-domain for each parameter. Hence the data has a symmetry about this mean, and the noise μᵢ=μ₍ᵢ₎ reflects this too. So both methods above represent symmetrical adjustments to the data which have little effect on the new estimates.

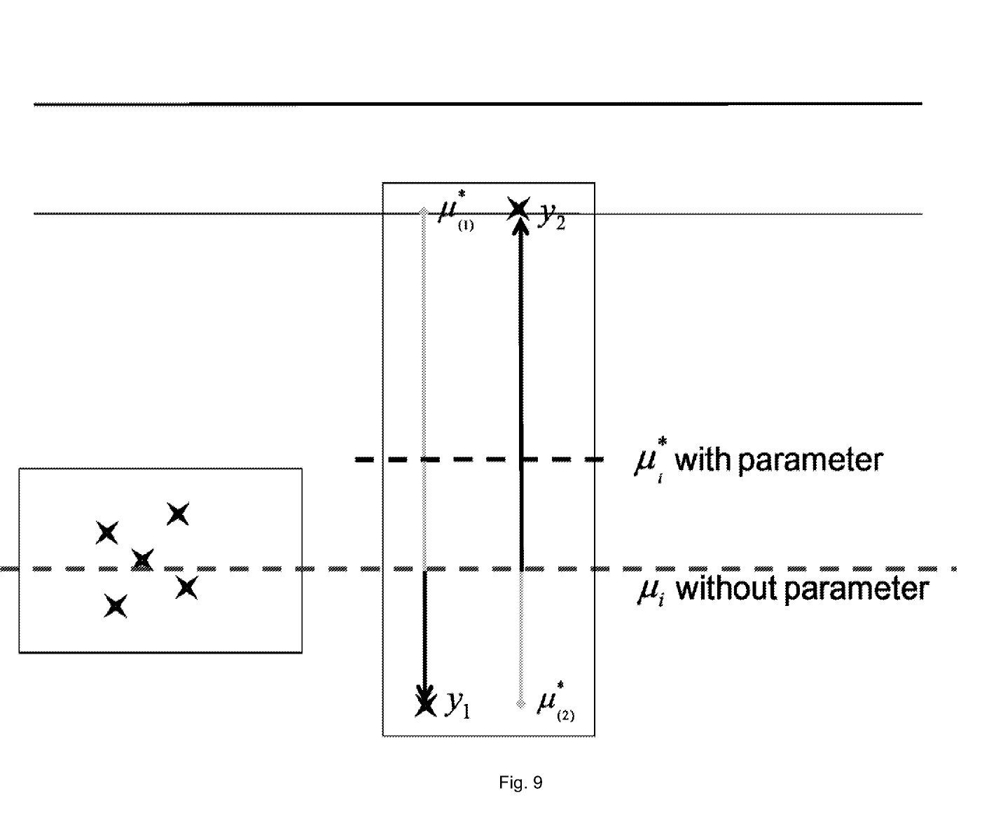

7.2.4 Consider the example illustrated in FIG. 9. Here we have a well populated domain with data points on the left defining a value of μᵢ shown as the lower dashed line. Then a new parameter based solely upon two data points y₁, y₂ is considered, this will move the ordinary estimates to the mid-point of the two points shown as μ*ᵢ the upper dashed line. With this parameter included the Case Deleted model for y₁ will produce μ*₍₁₎=y₂ and similarly the Case Deleted model for y₂ will produce μ*₍₂₎=y₁. The Deviances calculated for this parameter will show SD(yᵢ,μᵢ)>SD*(yᵢ,μ*ᵢ) but here the “Case Deleted” Deviance will be substantially worse CDD*(yᵢ,μ*₍ᵢ₎)>>SD(yᵢ,μᵢ). The symmetry of the adjustments can be seen easily here, and hence despite the failure of the extra parameter to add value, we can see why its value remains unchanged.

7.3 The Need for a Variance Penalty Function to Drive the Adjustor

7.3.1 Looking again at the formulation of the “Case Deleted” Estimates μ₍ᵢ₎, notice that they involve terms representing the mean μᵢ and through the Hat diagonal hᵢ the variance. Instead therefore we need to develop a penalty function to reward the model for good mean values and penalise by increasing variance.

7.3.2 However we cannot simply replace μᵢ with μ₍ᵢ₎ in the likelihood and refit, since the extra deviance introduced already possesses the symmetry above, and hence there is little impact on the parameters values by the method.

7.3.3 Now let's focus instead on a more direct penalty function. Take the results of the free fit μᵢ with corresponding μ₍ᵢ₎. Now consider that the variance introduced by a parameter, as expressed by the Variance/Covariance matrix will be scaled if the parameter itself is artificially scaled. Specifically the impact on the covariances will allow the model to rebalance in the presence of correlated parameters.

7.3.4 The Variance/Covariance matrix itself will adjust simply according to the normal result for scaled variances. Var(λYᵢ)=λ²Var(Yᵢ). In this case the elements of the Variance/Covariance matrix need to be replaced with

$${C}_{jk}^{*} = \{ \begin{matrix}Var ( {λ}_{j} {β}_{j} ) = {λ}_{j}^{2} Var ( {β}_{j} ) , & j = k \\ Cov ( {λ}_{j} {β}_{j} , {λ}_{k} {β}_{k} ) = {λ}_{j} {λ}_{k} Cov ( {β}_{j} , {β}_{k} ) , & j \neq k\end{matrix} \\ where \\ {λ}_{j} = \frac{{β}_{j}^{*}}{{β}_{j}}$$

7.3.5 From this a scaled version of the Hat diagonal can be calculated.

$${h}_{i}^{*} = {\sum }_{jk} {X}_{ij} {C}_{jk}^{*} {X}_{ik} {W}_{i} = {\sum }_{jk} \frac{{X}_{ij} {β}_{j}^{*} {C}_{jk} {X}_{ik} {β}_{k}^{*} {W}_{i}}{{β}_{j} {β}_{k}}$$

which produces new Linear Predictors

$${η}_{( i )}^{*} = {η}_{i}^{*} - ( \frac{{h}_{i}^{*}}{1 - {h}_{i}^{*}} ) {g}^{′} ( {μ}_{i} ) ( {y}_{i} - {μ}_{i} )$$

and “Case Deleted” Estimates μ*₍ᵢ₎=g₋₁(η*₍ᵢ₎)

7.4 Idea of a Model Depreciation Index

7.4.1 To draw an analogy, the value of a model is like that of a used car. The instant it rolls off the forecourt it looses a chunk of its predictive power simply by virtue of the fact that it is now being used on new data rather than measured in a circular fashion against the data used to define it.

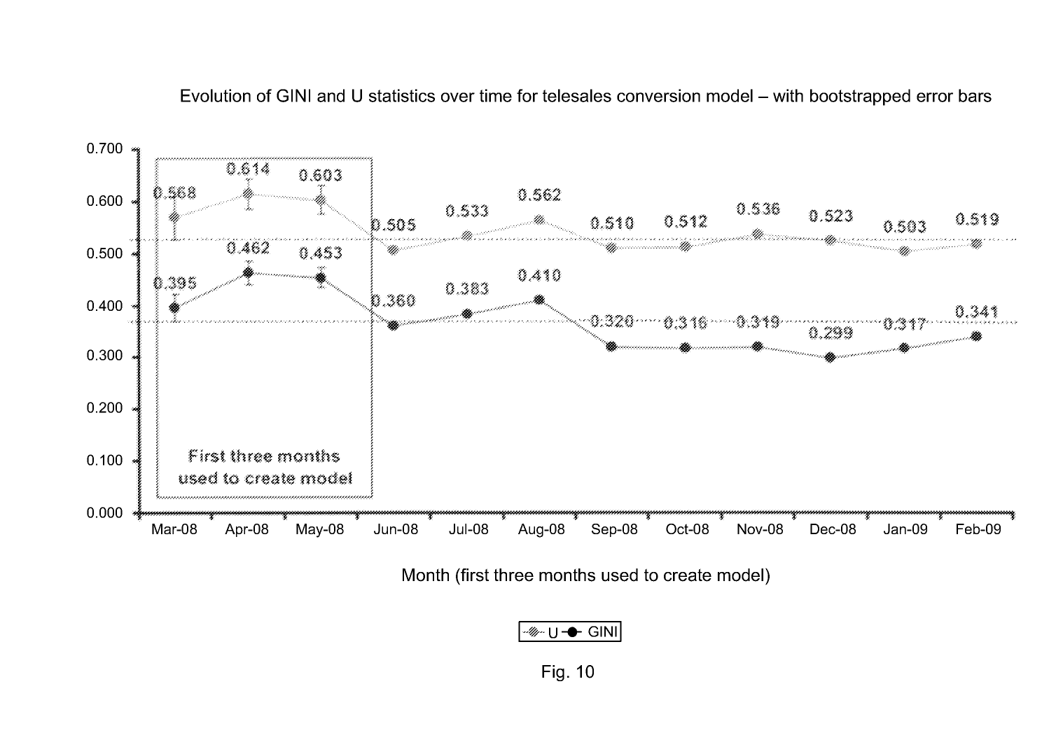

7.4.2 As time passes, the value decreases further, as was illustrated by a model validation working party organised as part of the Institute of Actuaries Giro Conference 2009. FIG. 10 is an extract from page 10 of their report (Berry J, et al).

7.4.3 The Noise Reduction technique provides an indication of that initial depreciation, by reference to the scale factors which have been derived.

7.4.4 Without applying the scale factors, deploying the full model, would result in a worse model than the scaled one.

8. Calculation of Noise Reduced Model

8.1 Specification of Penalty Function and Two Tier Modelling Process

8.1.1 First obtain the results of the normal Generalized Linear Model fit, as outlined in A.1.10. Next calculate the “Case Deleted” Estimates

$${η}_{( i )} = {η}_{i} - ( \frac{{h}_{i}}{1 - {h}_{i}} ) {g}^{′} ( {μ}_{i} ) ( {y}_{i} - {μ}_{i} ) .$$

Now using the superscript * to denote new parameters and estimates β*ⱼ, η*ᵢ, μ*ᵢ which we will estimate from the new penalty function.

8.1.2 The Hat diagonal hᵢ is a measure of the influence attaching to the data point yᵢ with (1−hᵢ) the influence of the remaining points. This includes the effect of the Variance of parameter βⱼ, Var(βⱼ)and the Covariance of this with the other parameters Cov(βⱼ,βₖ). Now suppose that βⱼ is scaled back to a value β*ⱼ, this will reduce the variance to

$$Var ( {β}_{j}^{*} ) = {( \frac{{β}_{j}^{*}}{{β}_{j}} )}^{2} Var ( {β}_{j} )$$

### and the Covariances to

$${C}_{jk}^{*} = Cov ( {β}_{j}^{*} , {β}_{k}^{*} ) = ( \frac{{β}_{j}^{*}}{{β}_{j}} \frac{{β}_{k}^{*}}{{β}_{k}} ) Cov ( {β}_{j} , {β}_{k} ) .$$

These are not the same as the variance results that would occur from a model which had generated these parameter values directly. Using these values we can scale back the “Case Deleted” Estimates that would apply to the new parameters.

$${η}_{( i )}^{*} = {η}_{i}^{*} - ( \frac{{h}_{i}^{*}}{1 - {h}_{i}^{*}} ) {g}^{′} ( {μ}_{i} ) ( {y}_{i} - {μ}_{i} ) where$$

$${h}_{i}^{*} = {\sum }_{jk} \frac{{X}_{ij} {β}_{j}^{*} {C}_{jk} {X}_{ik} {β}_{k}^{*} {W}_{i}}{{β}_{j} {β}_{k}}$$

8.2 Non-linear model algorithm

8.2.1 Now using the results developed in Appendix B with the new definition of F*ᵢ being

$${F}_{i}^{*} = {η}_{( i )}^{*} = {η}_{i}^{*} - ( \frac{{h}_{i}^{*}}{1 - {h}_{i}^{*}} ) {g}^{′} ( {μ}_{i} ) ( {y}_{i} - {μ}_{i} )$$

8.2.2 Notation will gain super and subscripts as required giving a new objective as

$${l}_{( i )}^{*} = l ( {y}_{i} , {θ}_{( i )}^{*} ) = {\sum }_{i} \frac{{ω}_{i}}{ϕ} ( {y}_{i} {θ}_{( i )}^{*} - a ( {θ}_{( i )}^{*} ) ) + b ( {y}_{i} , ϕ )$$

8.2.3 Score Statistic of

$${U}_{j}^{*} = \frac{\partial {l}_{( i )}^{*}}{\partial {β}_{j}^{*}} = {\sum }_{i} \frac{\partial {l}_{( i )}^{*}}{\partial {θ}_{( i )}^{*}} \frac{\partial {θ}_{( i )}^{*}}{\partial {μ}_{( i )}^{*}} \frac{\partial {μ}_{( i )}^{*}}{\partial {η}_{( i )}^{*}} \frac{\partial {η}_{( i )}^{*}}{\partial {β}_{j}^{*}} with$$

$$\frac{\partial {l}_{( i )}^{*}}{\partial {θ}_{( i )}^{*}} = {\sum }_{i} \frac{{ω}_{i}}{ϕ} ( {y}_{i} - {μ}_{( i )}^{*} ) , \frac{\partial {μ}_{( i )}^{*}}{\partial {θ}_{( i )}^{*}} = {a}^{″} ( {θ}_{( i )}^{*} ) = V ( {μ}_{( i )}^{*} ) , \\ \frac{\partial {η}_{( i )}^{*}}{\partial {μ}_{( i )}^{*}} = {g}^{′} ( {μ}_{( i )}^{*} )$$

8.2.4 Calculating

$${F}_{ij}^{′ *} = \frac{\partial {η}_{( i )}^{*}}{\partial {β}_{j}^{*}} = {X}_{ij} - ( \frac{{H}_{ij}^{′ *}}{{( 1 - {h}_{i}^{*} )}^{2}} ) {g}^{′} ( {μ}_{i} ) ( {y}_{i} - {μ}_{i} ) with$$

$${H}_{ij}^{′ *} = {\sum }_{k} \frac{2 {X}_{ij} {C}_{jk} {X}_{ik} {β}_{k}^{*} {W}_{i}}{{β}_{j} {β}_{k}}$$

8.2.5 From B.1.3 we have

$${U}_{j}^{*} = \frac{\partial {l}_{( i )}^{*}}{\partial {β}_{j}^{*}} = {\sum }_{i} \frac{{ω}_{i} {F}_{ij}^{′ *} ( {y}_{i} - {μ}_{( i )}^{*} )}{{ϕg}^{′} ( {μ}_{( i )}^{*} ) V ( {μ}_{( i )}^{*} )} = {\sum }_{i} {F}_{ij}^{′ *} {W}_{( i )}^{*} {g}^{′} ( {μ}_{( i )}^{*} ) ( {y}_{i} - {μ}_{( i )}^{*} )$$

$$where$$

$${W}_{( i )}^{*} = \frac{{ω}_{i}}{{ϕ ( {g}^{′} ( {μ}_{( i )}^{*} ) )}^{2} V ( {μ}_{( i )}^{*} )}$$

$${U}_{jk}^{′ *} = \frac{\partial {U}_{j}^{*}}{\partial {β}_{k}} = {\sum }_{i} ( {F}_{ijk}^{″ *} {W}_{( i )}^{*} {g}^{′} ( {μ}_{( i )}^{*} ) + {F}_{ij}^{′ *} \frac{\partial ( {W}_{( i )}^{*} {g}^{′} ( {μ}_{( i )}^{*} ) )}{\partial {β}_{k}} ) ( {y}_{i} - {μ}_{( i )}^{*} ) - {F}_{ij}^{′ *} {W}_{( i )}^{*} {F}_{ik}^{′ *}$$

$$where$$

$${F}_{ijk}^{″ *} = - ( \frac{{H}_{ijk}^{″ *}}{{( 1 - {h}_{i}^{*} )}^{2}} ) {g}^{′} ( {u}_{i} ) ( {y}_{i} - {μ}_{i} ) - 2 ( \frac{{H}_{ij}^{′ *} {H}_{ik}^{′ *}}{{( 1 - {h}_{i}^{*} )}^{3}} ) {g}^{′} ( {u}_{i} ) ( {y}_{i} - {μ}_{i} )$$

$$and {H}_{ijk}^{″ *} = \frac{2 {X}_{ij} {C}_{jk} {X}_{ik} {W}_{i}}{{β}_{j} {β}_{k}}$$

8.2.7 In this case the matrix U′*ⱼₖ has not been decomposed into eigenvectors.

$${}_{}^{m + 1}{β}{}_{j}^{*} = {}_{}^{m}{β}{}_{j}^{*} + {\sum }_{ik} {( {U}_{jk}^{′ *} )}^{- 1} {F}_{ij}^{′ *} {}_{}^{m}{W}{}_{( i )}^{*} {g}^{′} ( {}_{}^{m}{μ}{}_{( i )}^{*} ) ( {y}_{i} - {}_{}^{m}{μ}{}_{( i )}^{*} )$$

9. Worked Example

9.1 Log Poisson Frequency Model

9.1.1 This example is taken from a Motor Third Party Bodily Injury example dataset. This model has a large sample size of 500,000 with around 30,000 responses.

9.1.2 A full complexity model was built upon the data, using 31 factors with 54 parameters, of which 8 were interactions.

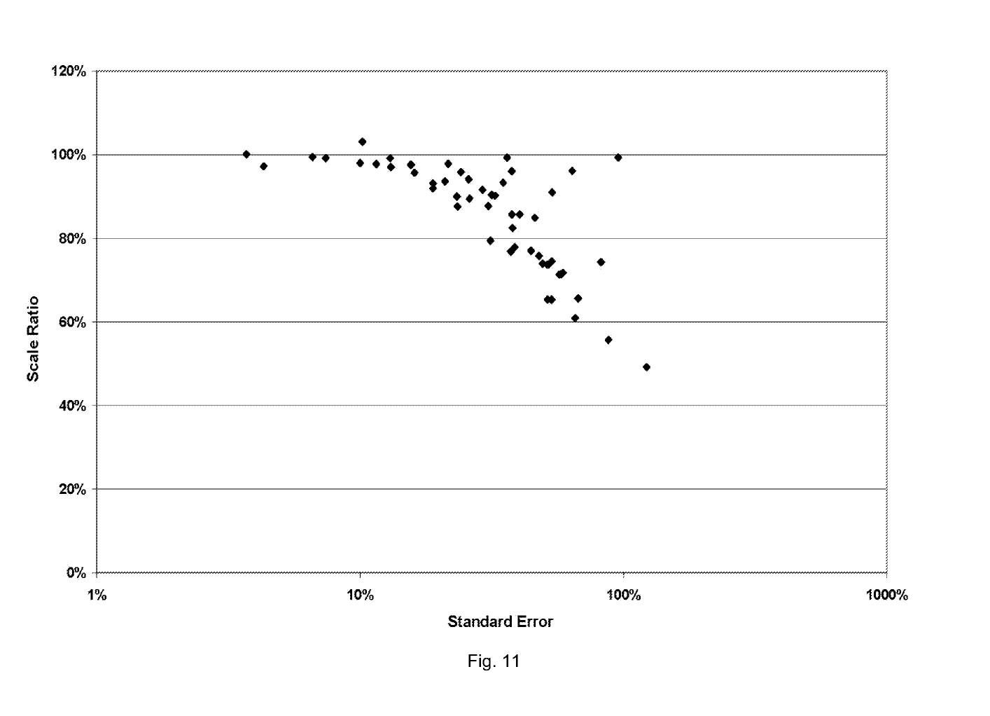

9.1.3 FIG. 11 shows the relationship between the Standard Error (x-axis) reported by the GLM and the Scale Factor (y-axis) recommended by the Noise Reduction technique.

9.1.4 A few of parameters were retained beyond the normal acceptance threshold, to show the fall-off between higher errors and the scale factor.

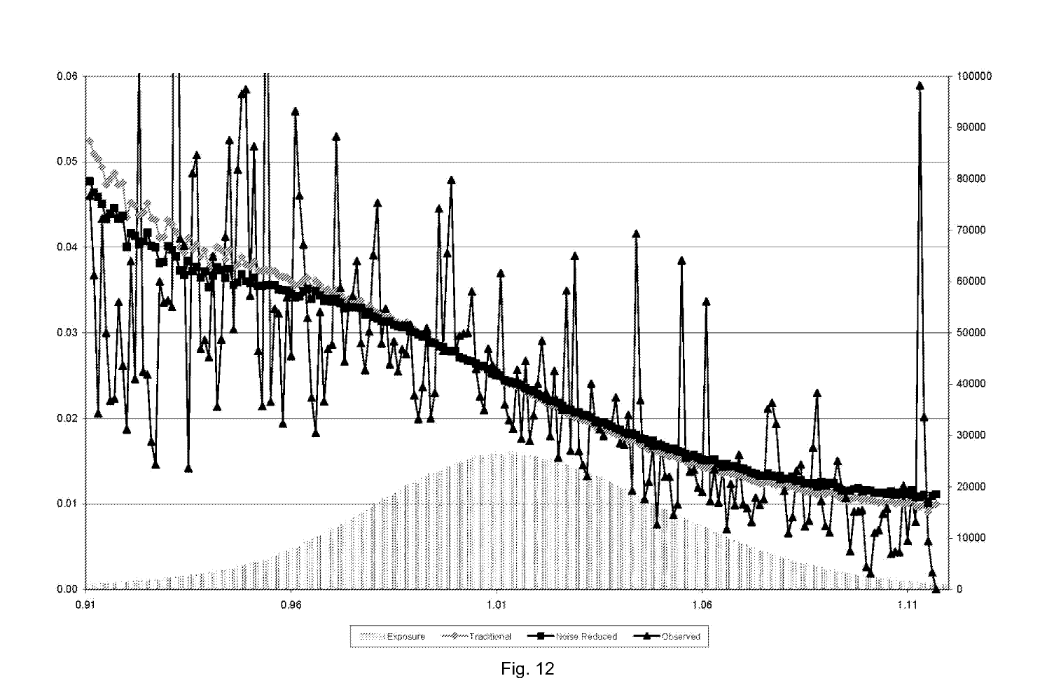

9.1.5 FIG. 12 shows the ratio of the two models (x-axis), and the average observed response and model prediction values (y-axis), plus the exposure as bars (2^{nd} y-axis). Models here have been fitted on the training dataset, and then rescored against the hold-out dataset The chart then measures their value against observed data from the hold-out dataset.

9.1.6 The models show varying predictions with a ratio substantially between +/−5%. The noise reduced model produces predictions which are scaled towards the mean, which temper the predictions made by the GLM at the extremes of the distribution.

9.1.7 Using a simple business model with a price comparison website level of elasticity fixed at 10 shows a profit margin improvement in this example of 0.57% at constant volumes.

9.2 Log Gamma Severity Model

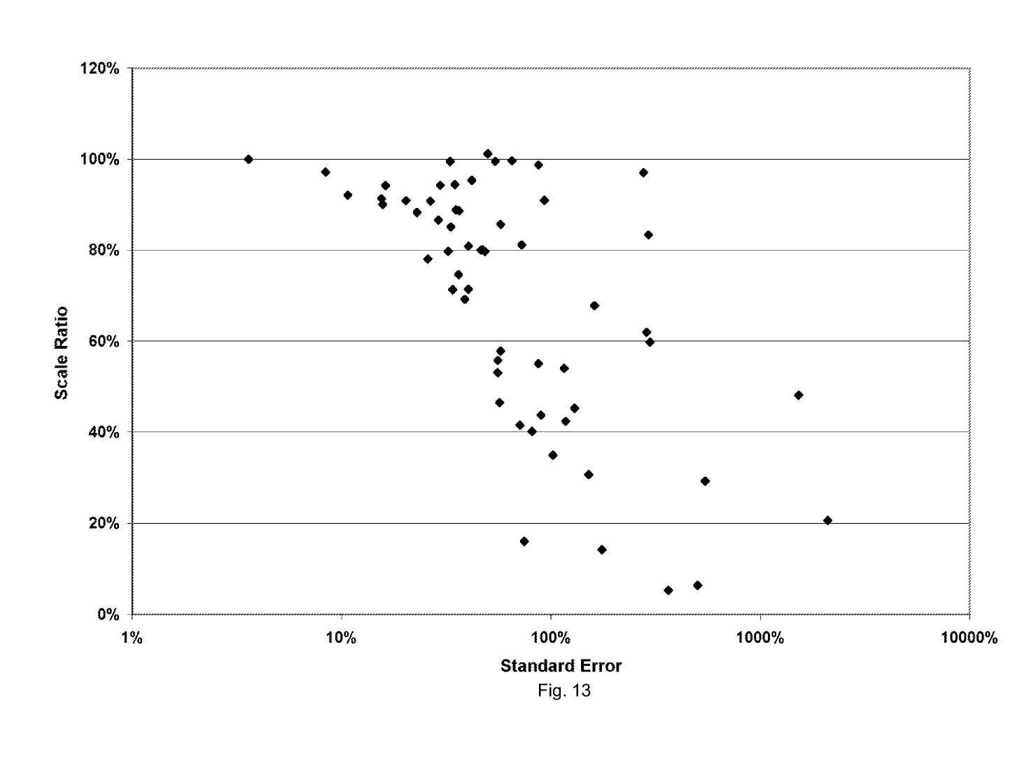

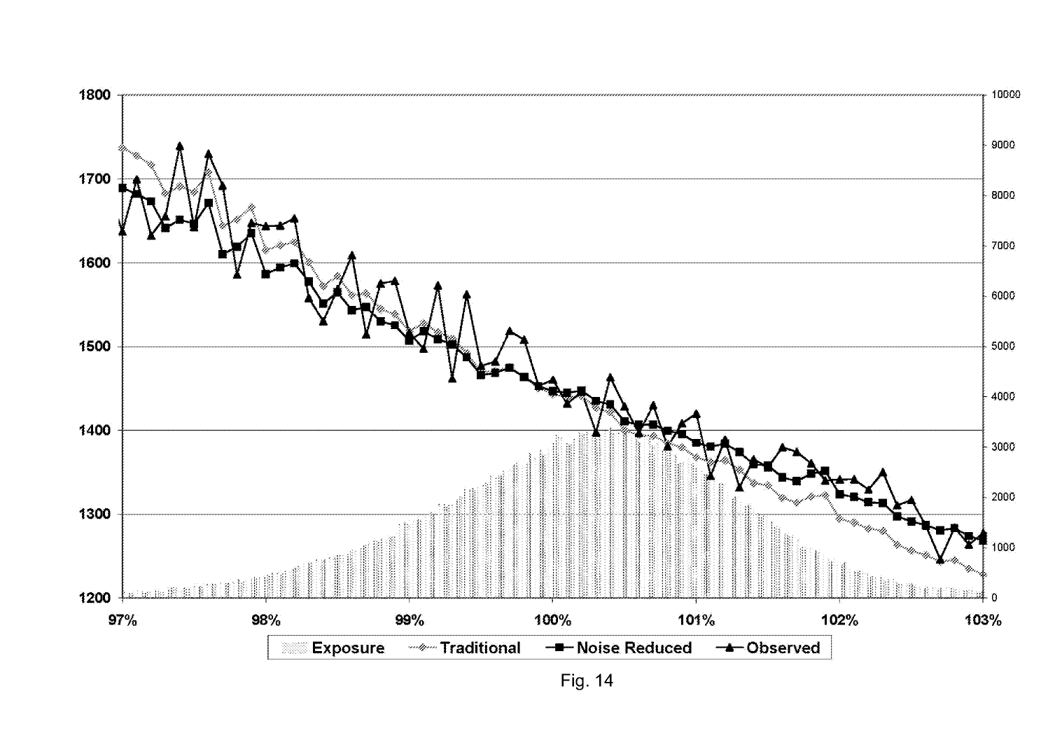

9.2.1 This example (see FIGS. 13 and 14) is taken from a Motor Accidental Damage Severity example dataset. To contrast with the previous frequency model, a sample size of 12,000 was used with an average response of 1,450.

9.2.2 A full complexity model was built upon the data, using 18 factors with 59 parameters, of which 17 were interactions.

9.2.3 Using a simple business model with a price comparison website level of elasticity fixed at 10 shows a profit margin improvement in this example of 0.69% at constant volumes.

9.3 Logit Binomial Proportion of Collisions with Bodily Injury Model

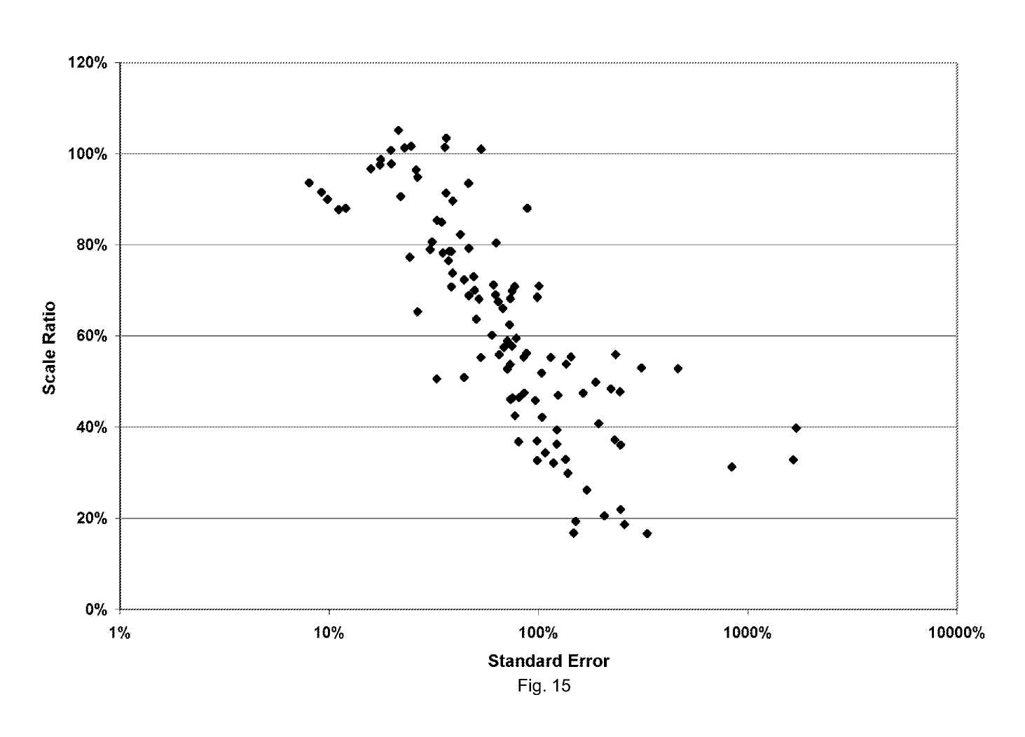

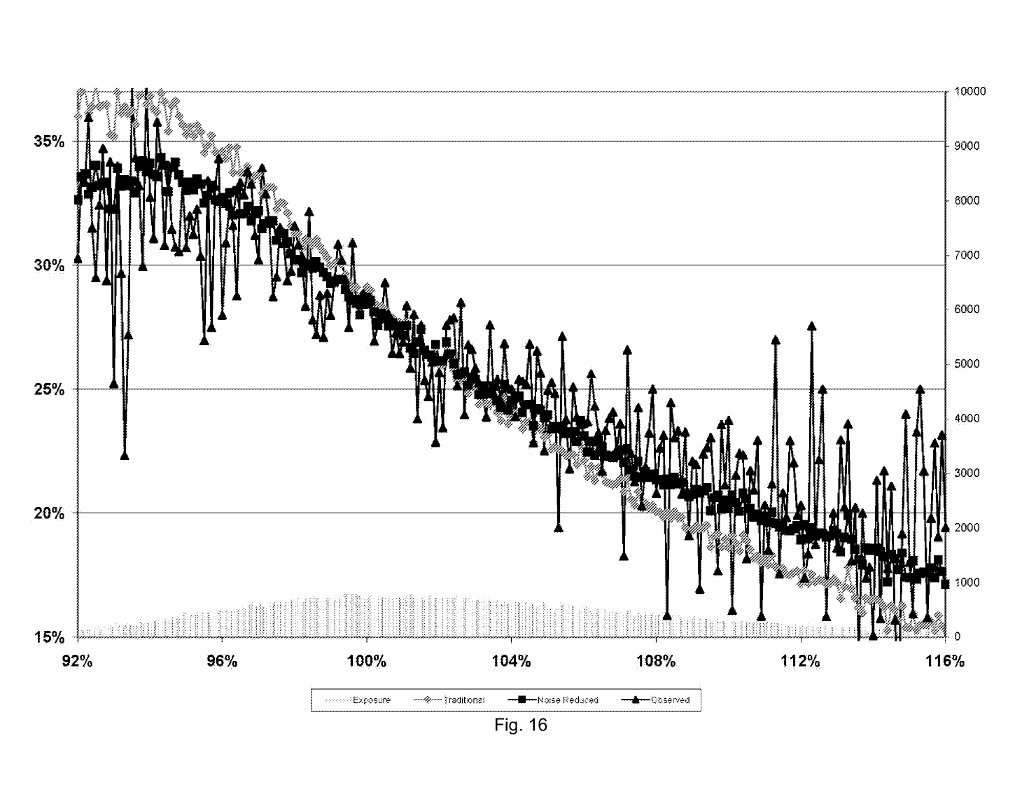

9.3.1 This example (see FIGS. 15 and 16) is a propensity model built on a Motor dataset using collision as the exposure measure, and proportion of Bodily Injuries on the claim as the response. Such an approach is sometimes used to increase the patterns detected in sparse Bodily Injury data. The sample size was 22,000.

9.3.2 The model is using 19 factors with 108 parameters with no interactions.

9.3.3 Using a simple business model with a price comparison website level of elasticity fixed at 10 shows a large profit margin improvement in this example of 3.4% at constant volumes.

9.4 Poor Model

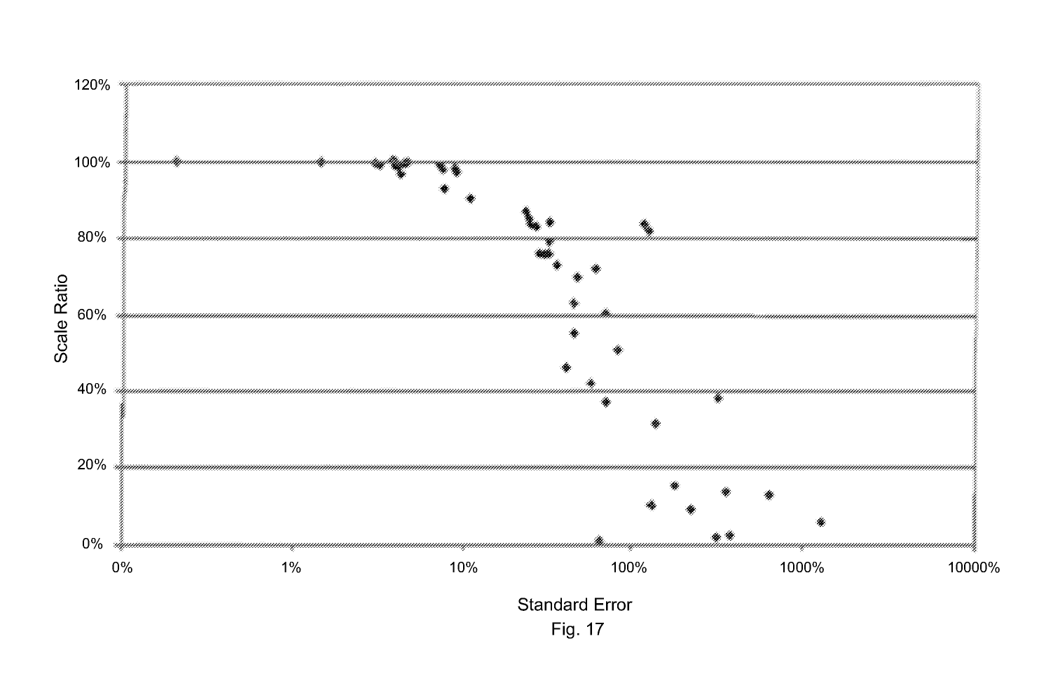

9.4.1 In this example a particularly poor set of parameters was retained to find out how effectively the technique was at removing ones that are not significant. FIG. 17 shows that scale factors quite close to zero are achieved. The resultant model however was still very poor, as the technique does nothing to add significant factors which are missing from the original model.

10. Examples of Practical Applications for the Present Methods

Examples of the types of model where the present techniques are applicable to provide more accurately predictive models.

Claim frequency—This type of model will use physical characteristics of the insured object such as type of vehicle, engine power, age of vehicle and so on, and using these will determine how many of them will crash in a given year.

This knowledge is useful not just for the purposes of setting the insurance premium itself, but also guides the capacity of repair garages used to repair the cars.

Claims cost—This model is a similar concept to claims frequency, except that the purpose is to determine the amount of damage per vehicle. Value of vehicle and cost of repair parts will be additional factors in this model.

Again the values can be used to define insurance costs, but in addition the amount of damage relative to the vehicle value is a key determining fact in deciding if a damaged vehicle should be repaired or scrapped.

Propensity—These types of model create a likelihood of an event occurring. There are many types that might be produced, and hence a wide variety of applications, including insurance and a wide range of other scenarios.

For example a propensity model may be developed to determine if a person will respond to a piece of mail. This multiplied by the value of the response, gives the benefit of mailing a person, and can be compared to the cost of the operation. Increasing use of this technique results in fewer blanket junk-mail activities, and better targeted mail towards those who want to receive it.

Another example is generating a model to predict the chance that a person will renew a product this year. This may be used to target price discounts and other rewards to the undecided customers.

A further example is generating a model to determine the chance that a post-operative patient discharged today will need to be readmitted later with complications. Hospitals are under increased pressure to discharge patients early to free up beds, and for some patients this is beneficial as they will recover better at home with family. However for others (depending on the operation type, and patient age and history for example), early discharge could result in relapse, and longer more expensive care later. Hence the ability to weight up all the influencing factors to make the best decision can improve care and aid difficult decisions around the allocation of resources.

In all of these examples the model is used to provide information where the outcome depends on several (possibly very many) factors. The present methods provide an adjustment to the results which make them more predictive of future outcomes, by insulating them from noise in the visible data.

This model information is used to make a real-world choices about the allocation of resources, such as whether to fix a car or scrap it, to mail a person or leave them in peace, to discharge a patient or keep them in hospital.

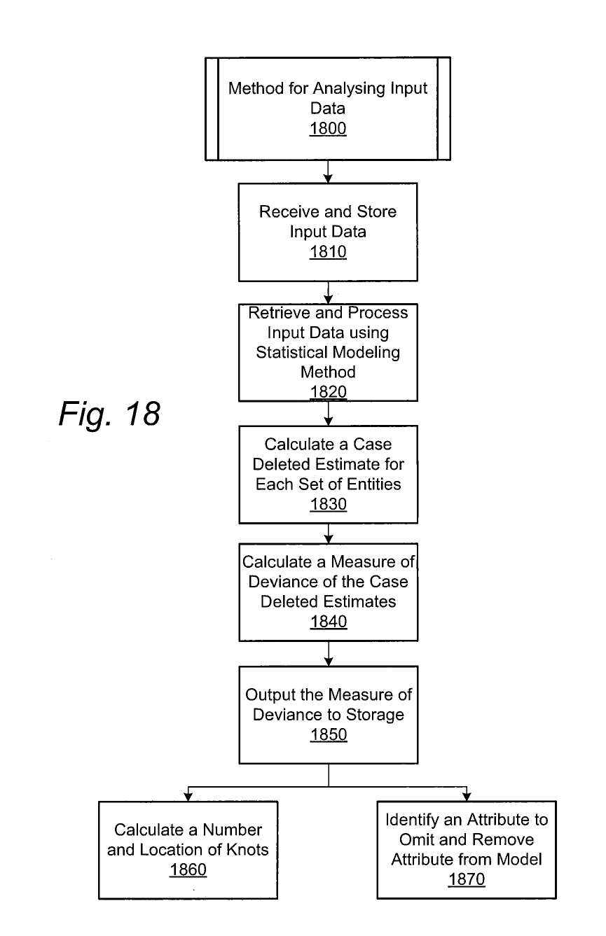

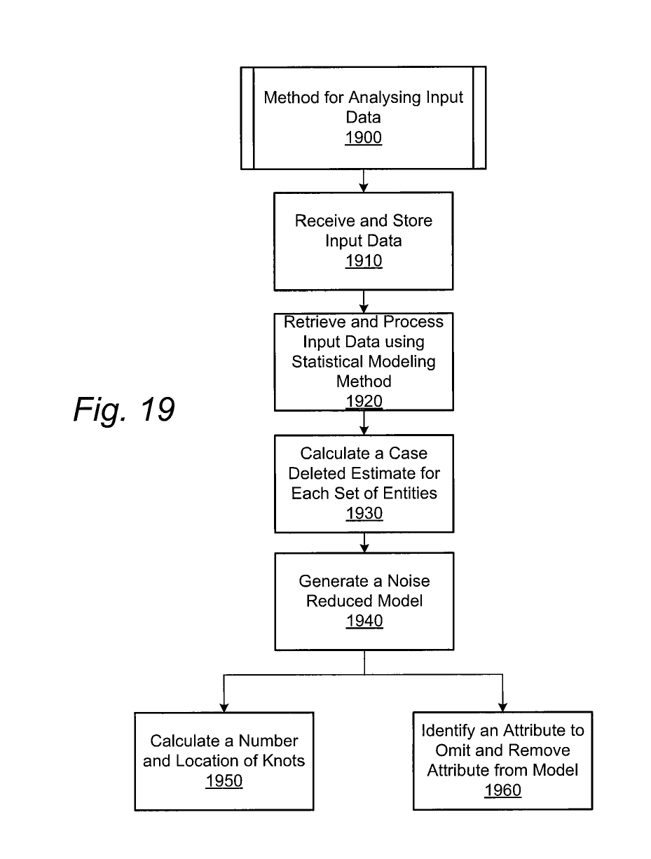

Before turning to the process flow diagrams of FIGS. 18 and 19, it is noted that embodiments described herein may be practiced using an alternative order of the steps illustrated in FIGS. 18 and 19. That is, the process flows illustrated in FIGS. 18 and 19 are provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope and spirit of the embodiments.

Turning to FIG. 18, an example embodiment of a method 1800 for analysing input data using a processor is described. In certain embodiments, the input data comprises, for each set of physical entities, attribute values representing attributes of the respective physical entity and an outcome value representing an observed outcome for the respective physical entity. The analysis generates a model for predicting an outcome value for a further physical entity based on input data comprising attribute values associated with the further physical entity.

In FIG. 18, the method 1800 includes receiving input data and storing the input data in an electronic data storage at step 1810. The method 1800 further includes retrieving the input data from the data storage and processing the input data using a statistical modelling method to generate a model based on the input data at step 1820. In various embodiments, the model generated in step 1820 may comprise any of the models described above or combinations thereof. For example, as discussed above, the statistical modelling method may generate the model as a Generalised Linear Model or a Generalised Non-linear Model, among embodiments.

Proceeding to step 1830, the method 1800 further includes calculating a case deleted estimate of the outcome value for each set of physical entities. For example, calculating case deleted estimates at step 1830 may be performed according to the methods, models, and calculations described above in sections 2 and 3. At step 1840, the method 1800 proceeds to calculating a measure of deviance of the case deleted estimates from the outcome values of the input data. At step 850, the method includes outputting the measure of deviance to data storage for retrieval by a user.

In certain other embodiments, the method 1800 may further include calculating a number and location of knots to include in the model to minimise the measure of deviance at step 1860. For example, calculating knots at step 1860 may be performed according to the methods, models, and calculations described above. Additionally or alternatively, the method 1800 may further include identifying at least one attribute to omit from the model based on an associated deviance measure of the at least one attribute and removing the at least one attribute from the model at step 1870, according to the methods, models, and calculations described above.

Turning to FIG. 19, an example embodiment of a method 1900 for analysing input data using a processor is described. In certain embodiments, the input data comprises, for each set of physical entities, attribute values representing attributes of the respective physical entity and an outcome value representing an observed outcome for the respective physical entity. The analysis generates a model for predicting an outcome value for a further physical entity based on input data comprising attribute values associated with the further physical entity.

In FIG. 19, the method 1900 includes receiving input data and storing the input data in an electronic data storage at step 1910. The method 1900 further includes retrieving the input data from the data storage and processing the input data using a statistical modelling method to generate an intermediate model based on the input data, the intermediate model comprising parameter estimates and a variance/covariance matrix at step 1920. In various embodiments, the intermediate model generated in step 1920 may comprise any of the models described above or combinations thereof. For example, as discussed above, the statistical modelling method may generate the model as a Generalised Linear Model or a Generalised Non-linear Model, among embodiments.

Proceeding to step 1930, the method 1900 further includes calculating a case deleted estimate of the outcome value for each set of physical entities based on the intermediate model. For example, calculating case deleted estimates at step 1930 may be performed according to the methods, models, and calculations described above in sections 2 and 3.

In one embodiment, calculating the case deleted estimates at step 1930 includes calculating, for each entity, the case deleted estimate directly and without running the intermediate model for the entity on the basis of the input data with the data associated with the entity omitted. In another embodiment, case deleted estimates may be calculated at step 1930 directly for each entity by calculating case deleted linear predictors and deriving the case deleted estimates therefrom using an inverse link function. In this embodiment, the case deleted linear predictor is calculated for each entity by adjusting a linear predictor provided by the intermediate model by subtracting an amount corresponding to an influence on the model caused by the outcome value for the entity, as also described above, wherein the influence on the model caused by the outcome value for an entity is calculated by multiplying a distance from the model to the respective outcome value by an influence factor and by a rate of change of the linear predictor by the estimate. In still another embodiment, calculating the case deleted estimates at step 1930 includes calculating, for each entity, a case deleted estimate by running the intermediate model based on the input data with the attribute values associated with the entity omitted to generate a respective set of case deleted model parameters.

At step 1940, the method 1900 proceeds to generating a noise reduced model comprising noise reduced parameters, a noise reduced variance/covariance matrix, and noise reduced case deleted estimates using an iterative process to minimise a measure of deviance of the noise reduced case deleted estimates from the outcome values of the input data. The generation of the noise reduced model may, in various embodiments, be performed according to the methods, models, and calculations described above.

In certain other embodiments, the method 1900 may further include calculating a number and location of knots to include in the noise reduced model to minimise the measure of deviance at step 1950. For example, calculating knots at step 1950 may be performed according to the methods, models, and calculations described above. Additionally or alternatively, in other embodiments, the method 1900 may further include identifying at least one attribute to omit from the model based on a measure of deviance of the at least one attribute relative to the noise reduced model and removing the at least one attribute from the model at step 1960, according to the methods, models, and calculations described above.

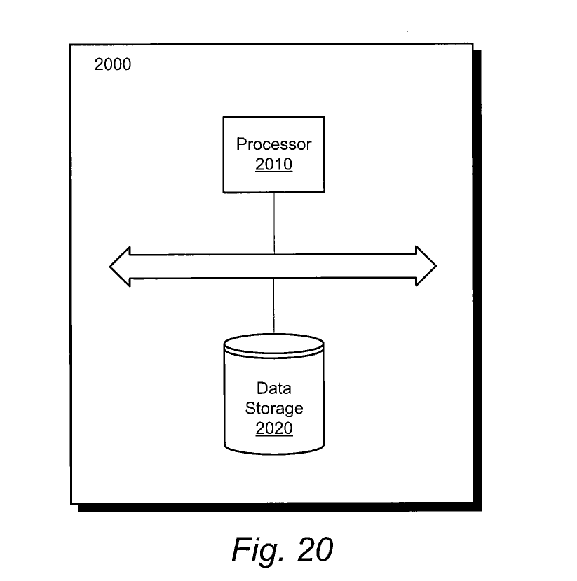

Turning to FIG. 20, an example hardware circuit diagram of a general purpose computing device 2000 is described. The computing device 2000 includes a processor 2010 and a data storage 2020. In various embodiments, the processor 2010 comprises any well known general purpose arithmetic processor, for example. The data storage 2020 comprises any well known memory device or tangible computer-readable medium that stores computer-readable instructions to be executed by the processor 2010. The data storage 2020 stores computer-readable instructions thereon that, when executed by the processor 2010, direct the processor 2010 to execute various aspects of the present invention described herein, such as the methods 1800 and 1900 described above, for example. In operation, the processor 2010 is configured to retrieve computer-readable instructions stored on the data storage 2020 and execute the computer-readable instructions to implement various aspects and features of the present invention. For example, the processor 2010 may be adapted and configured to execute the processes described above with reference to FIGS. 18 and 19.

### APPENDICES

### Appendix A. Generalized Linear Models

A.1 Derivation and Notation

A.1.1 The following derivation is drawn from Anderson et al. and Dobson and although well known is included so that the non-linear variant can be derived using the same notation in the main body of the text.

A.1.2 Let Yᵢ be a series of random variables belonging to the exponential family of distributions, expressed in canonical form with natural parameter θᵢ by the pdf.

$$f ( {y}_{i} , {θ}_{i} ) = exp ( \frac{{ω}_{i}}{ϕ} ( {y}_{i} {θ}_{i} - a ( {θ}_{i} ) ) + b ( {y}_{i} , ϕ ) )$$

where ωᵢ is a constant related to Yᵢ representing the weight which is commonly the exposure for insurance applications, and φ is the scale parameter

A.1.3 Given

$$\int f ( {y}_{i} , {θ}_{i} ) d {y}_{i} = 1 we have$$

$$\int \frac{\partial }{\partial {θ}_{i}} f ( {y}_{i} , {θ}_{i} ) = 0 = \int \frac{{ω}_{i}}{ϕ} ( {y}_{i} - {a}^{′} ( {θ}_{i} ) ) f ( {y}_{i} , {θ}_{i} ) and$$

$$\int \frac{{\partial }^{2}}{\partial {θ}_{i}^{2}} f ( {y}_{i} , {θ}_{i} ) = 0 = \int [ \frac{{ω}_{i}}{ϕ} ( - {a}^{″} ( {θ}_{i} ) ) + {( \frac{{ω}_{i}}{ϕ} ( {y}_{i} - {a}^{′} ( {θ}_{i} ) ) )}^{2} ] f ( {y}_{i} , {θ}_{i} )$$

A.1.4 The first of these gives E[Yᵢ]=α′(θᵢ) and substituting this into the second gives

$${a}^{″} ( {θ}_{i} ) = \frac{{ω}_{i}}{ϕ} E [ {( {Y}_{i} - E [ {Y}_{i} ] )}^{2} ] = \frac{{ω}_{i}}{ϕ} Var [ {Y}_{i} ]$$

$$we define$$

$${μ}_{i} = E [ {Y}_{i} ] = {a}^{′} ( {θ}_{i} ) and$$

$$V ( {μ}_{i} ) = {a}^{″} ( {θ}_{i} ) = {a}^{″} ( {a}^{′ - 1} ( {μ}_{i} ) ) = \frac{{ω}_{i}}{ϕ} Var [ {Y}_{i} ]$$

A.1.5 Let the log likelihood function be denoted by

$$l ( {y}_{i} , {θ}_{i} ) = {\sum }_{i} \frac{{ω}_{i}}{ϕ} ( {y}_{i} {θ}_{i} - a ( {θ}_{i} ) ) + b ( {y}_{i} , ϕ )$$

A.1.6 Further define the linear predictor and the link function for the model ηᵢ=g(μᵢ), where the linear predictor is a linear combination of the parameters

$${η}_{i} = {\sum }_{j} {X}_{ij} {β}_{j} .$$

A.1.7 First we define the score statistic

$${U}_{j} = \frac{\partial l}{\partial {β}_{j}}$$

and obtain the result by deriving each of the following terms in order:

$${U}_{j} = {\sum }_{i} \frac{\partial {l}_{i}}{\partial {θ}_{i}} \frac{\partial {θ}_{i}}{\partial {μ}_{i}} \frac{\partial {μ}_{i}}{\partial {η}_{i}} \frac{\partial {η}_{i}}{\partial {β}_{j}} , \\ \frac{\partial {l}_{i}}{\partial {θ}_{i}} = \frac{{ω}_{i}}{ϕ} ( {y}_{i} - {a}^{′} ( {θ}_{i} ) ) = \frac{{ω}_{i}}{ϕ} ( {y}_{i} - {μ}_{i} ) , \\ \frac{\partial {μ}_{i}}{\partial {θ}_{i}} = {a}^{″} ( {θ}_{i} ) = V ( {μ}_{i} ) , \\ \frac{\partial {η}_{i}}{\partial {μ}_{i}} = {g}^{′} ( {μ}_{i} ) , \\ \frac{\partial {η}_{i}}{\partial {β}_{j}} = {X}_{ij} .$$

### Giving

$$\begin{matrix}{U}_{j} = \frac{\partial l}{\partial {β}_{j}} \\ = {\sum }_{i} \frac{{ω}_{i} {X}_{ij} ( {y}_{i} - {μ}_{i} )}{ϕ {g}^{′} ( {μ}_{i} ) V ( {μ}_{i} )} \\ = {\sum }_{i} {W}_{i} {g}^{′} ( {μ}_{i} ) {X}_{ij} ( {y}_{i} - {μ}_{i} )\end{matrix}$$

$$where {W}_{i} = \frac{{ω}_{i}}{{ϕ ( {g}^{′} ( {μ}_{i} ) )}^{2} V ( {μ}_{i} )}$$

for reasons that will become clearer below. Note also that

$$\begin{matrix}E [ {U}_{j} ] = E [ {\sum }_{i} {W}_{i} {g}^{′} ( {μ}_{i} ) {X}_{ij} ( {y}_{i} - {μ}_{i} ) ] \\ = {\sum }_{i} {W}_{i} {g}^{′} ( {μ}_{i} ) {X}_{ij} ( E [ {Y}_{i} ] - {μ}_{i} ) \\ = 0\end{matrix}$$

A.1.8 Next Dobson derives an approximation by first defining the information matrix

$${J}_{jk} = Cov ( {U}_{j} , {U}_{k} ) , and using E ⌊ {U}_{j} ⌋ = 0$$

$$\begin{matrix}{J}_{jk} = E [ ( {U}_{j} - E [ {U}_{j} ] ) ( {U}_{k} - E [ {U}_{k} ] ) ] \\ = E [ {U}_{j} {U}_{k} ] \\ = {\sum }_{i} {( \frac{{ω}_{i}}{ϕ {g}^{′} ( {μ}_{i} ) V ( {μ}_{i} )} )}^{2} {X}_{ij} {X}_{ik} E [ {( {Y}_{i} - {μ}_{i} )}^{2} ]\end{matrix}$$

$$\begin{matrix}{J}_{jk} = {\sum }_{i} {( \frac{{ω}_{i}}{ϕ {g}^{′} ( {μ}_{i} ) V ( {μ}_{i} )} )}^{2} {X}_{ij} {X}_{ik} Var [ {Y}_{i} ] \\ = {\sum }_{i} \frac{{ω}_{i}}{ϕ {( {g}^{′} ( {μ}_{i} ) )}^{2} V ( {μ}_{i} )} {X}_{ij} {X}_{ik} \\ = {\sum }_{i} {X}_{ij} {W}_{i} {X}_{ik}\end{matrix}$$

A.1.9 To solve for the parameters in the general case we use an extension of the Newton Raphson formula

$${ }^{m + 1} {β}_{j} {=}^{m} {β}_{j} - {\sum }_{k} {{{(}^{m} {U}_{jk}^{′} )}^{- 1}}^{m} {U}_{k}$$

to find the root of

$$\begin{matrix}{\sum }_{j} {U}_{j} = 0 {U}_{jk}^{′} \\ = \frac{\partial {U}_{j}}{\partial {β}_{k}} \\ = {\sum }_{i} \frac{\partial ( {W}_{i} {g}^{′} ( {μ}_{i} ) )}{\partial {β}_{k}} {X}_{ij} ( {y}_{i} - {μ}_{i} ) + \\ {W}_{i} {g}^{′} ( {μ}_{i} ) {X}_{ij} ( \frac{\partial ( {y}_{i} - {μ}_{i} )}{\partial {η}_{i}} \frac{\partial {η}_{i}}{\partial {β}_{k}} ) .\end{matrix}$$

the stationary point we are seeking

$${\sum }_{i} {ω}_{i} {X}_{ij} ( {y}_{i} - {μ}_{i} )$$

will be close to zero. For the structures noted in 5.2.3 this will be exactly zero, and

$${g}^{′} ( {μ}_{i} ) V ( {μ}_{i} ) = 1 , giving \frac{\partial ( {W}_{i} {g}^{′} ( {μ}_{i} ) )}{\partial {β}_{k}} = 0.$$

Hence the first term is normally ignored.

$$\begin{matrix}{U}_{jk}^{′} = \frac{\partial {U}_{j}}{\partial {β}_{k}} \\ = {\sum }_{i} - {W}_{i} {g}^{′} ( {μ}_{i} ) {X}_{ij} ( \frac{\partial {μ}_{i}}{\partial {η}_{i}} \frac{\partial {η}_{i}}{\partial {β}_{k}} ) \\ = {\sum }_{i} - {X}_{ij} {W}_{i} {X}_{ik} \\ = - {J}_{jk}\end{matrix}$$

A.1.10 Then we obtain the usual formula for iteration m, where

$${ }^{m + 1} {\hat{β}}_{j} {=}^{m} {\hat{β}}_{j} + {\sum }_{ik} {( {\sum }_{p} {X}_{pj}^{m} {W}_{p} {X}_{p k} )}^{- 1} {X}_{i k}^{m} {W}_{i} {g}^{′} {(}^{m} {μ}_{i} ) ( {y}_{i} {-}^{m} {μ}_{i} )$$

sometimes written as

$${ }^{m + 1} {\hat{β}}_{j} = {\sum }_{ik} {( {\sum }_{p} {X}_{pj}^{m} {W}_{p} {X}_{p k} )}^{- 1} {X}_{i k}^{m} {W}_{i}^{m} ( {η}_{i} + {g}^{′} {(}^{m} {μ}_{i} ) ( {y}_{i} {-}^{m} {μ}_{i} ) )$$

A.1.11 From these results the Variance-Covariance matrix is available

$${C}_{jk} = {( {\sum }_{p} {X}_{pj}^{m} {W}_{p} {X}_{p k} )}^{- 1}$$

along with the Hat Matrix

$${H}_{ip} = {\sum }_{jk} {W}_{i}^{1 / 2} {X}_{ij} {C}_{jk} {X}_{p k} {W}_{p}^{1 / 2}$$

and the Hat diagonal hᵢ=Hᵢᵢ

### Appendix B. Non-Linear Model Algorithm

B.1 Derivation and Validity

B.1.1 Taking the standard Generalized Linear Model form

$${η}_{i} = g ( {μ}_{i} ) = {\sum }_{j} {X}_{ij} {β}_{j}$$

and adding an extra function to represent a non-linear variant of the model. So that now ηᵢ=g(μᵢ)=F(Xᵢⱼ,βⱼ) denoted Fᵢ.

B.1.2 Let the log likelihood function and score statistics be the same as those of Appendix A above.

$$l ( {y}_{i} , {θ}_{i} ) = {\sum }_{i} \frac{{ω}_{i}}{ϕ} ( {y}_{i} {θ}_{i} - a ( {θ}_{i} ) ) + b ( {y}_{i} , ϕ ) and$$

$${U}_{j} = \frac{\partial l}{\partial {β}_{j}} = {\sum }_{i} \frac{\partial {l}_{i}}{\partial {θ}_{i}} \frac{\partial {θ}_{i}}{\partial {μ}_{i}} \frac{\partial {μ}_{i}}{\partial {η}_{i}} \frac{\partial {η}_{i}}{\partial {β}_{j}}$$

B.1.3 The first three terms are the same as Appendix A

$$\frac{\partial {l}_{i}}{\partial {θ}_{i}} = \frac{{ω}_{i}}{ϕ} ( {y}_{i} - {a}^{′} ( {θ}_{i} ) ) = \frac{{ω}_{i}}{ϕ} ( {y}_{i} - {μ}_{i} ) , \frac{\partial {μ}_{i}}{\partial {θ}_{i}} = {a}^{″} ( {θ}_{i} ) = V ( {μ}_{i} ) , \\ \frac{\partial {η}_{i}}{\partial {μ}_{i} } = {g}^{′} ( {μ}_{i} )$$

and the final term now becomes

$$\frac{\partial {η}_{i}}{\partial {β}_{j}} = {F}^{′} ( {X}_{ij} , {β}_{j} )$$

denoted F′ᵢⱼ. Giving

$${U}_{j} = \frac{\partial l}{\partial {β}_{j}} = {\sum }_{i} {F}_{ij}^{′} {W}_{i} {g}^{′} ( {μ}_{i} ) ( {y}_{i} - {μ}_{i} ) with {W}_{i} = \frac{{ω}_{i}}{{ϕ ( {g}^{′} ( {μ}_{i} ) )}^{2} V ( {μ}_{i} )}$$

as before.

B.1.4 At this point it is tempting to jump to the information matrix

$${J}_{jk} = {\sum }_{i} {F}_{ij}^{′} {W}_{i} {F}_{ik}^{′}$$

making use of the same approximation discussed in A.1.9 U′ⱼₖ=−Jⱼₖ. Which would define the iteration as

$${}_{}^{m + 1}{\hat{β}}{}_{j}^{} = {}_{}^{m}{\hat{β}}{}_{j}^{} + {\sum }_{ik} {( {\sum }_{p} {F}_{pj}^{′} {}_{}^{m}{W}{}_{p}^{} {F}_{p k}^{′} )}^{- 1} {F}_{ij}^{′} {}_{}^{m}{W}{}_{i}^{} {g}^{′} ( {}_{}^{m}{μ}{}_{i}^{} ) ( {y}_{i} - {}_{}^{m}{μ}{}_{i}^{} ) .$$

B.1.5 However first we must calculate

$${U}_{jk}^{′} = \frac{\partial {U}_{j}}{\partial {β}_{k}} = {\sum }_{i} ( {F}_{ijk}^{″} {W}_{i} {g}^{′} ( {μ}_{i} ) + {F}_{ij}^{′} \frac{\partial ( {W}_{i} {g}^{′} ( {μ}_{i} ) )}{\partial {β}_{k}} ) ( {y}_{i} - {μ}_{i} ) + {F}_{ij}^{′} {W}_{i} {g}^{′} ( - \frac{\partial {μ}_{i}}{\partial {η}_{i}} \frac{\partial {η}_{i}}{\partial {β}_{k}} ) = {\sum }_{i} ( {F}_{ijk}^{″} {W}_{i} {g}^{′} ( {μ}_{i} ) + {F}_{ij}^{′} \frac{\partial ( {W}_{i} {g}^{′} ( {μ}_{i} ) )}{\partial {β}_{k}} ) ( {y}_{i} - {μ}_{i} ) - {F}_{ij}^{′} {W}_{i} {F}_{ik}^{′} .$$

Note that the second of these terms represents the usual linear formula

$$- {J}_{jk} = - {\sum }_{i} {F}_{ij}^{′} {W}_{i} {F}_{ik}^{′} .$$

B.1.6 For the non-linear case we notice that the formula now involves an extra term in F″ᵢⱼₖ (which was zero in the linear case

$${F}_{ijk}^{″} = \frac{\partial {F}_{ij}^{′}}{\partial {β}_{k}} = \frac{\partial {X}_{ij}}{\partial {β}_{k}} = 0 ) .$$

Therefore the approximation will be less likely to be sufficiently close along the path we are seeking towards the stationary solution, and this may disrupt the convergence.

B.1.7 In general therefore we must instead fall back to the formula

$${}_{}^{m + 1}{β}{}_{j}^{} = {}_{}^{m}{β}{}_{j}^{} - {\sum }_{ik} {( {U}_{jk}^{′} )}^{- 1} {F}_{ij}^{′} {W}_{i} {g}^{′} ( {}_{}^{m}{μ}{}_{i}^{} ) ( {y}_{i} - {}_{}^{m}{μ}{}_{i}^{} )$$

which will display superior convergence characteristics for a wider range of link function and distribution structures.

B.1.8 Numerical testing has shown cases where B.1.4 diverges rapidly, and B.1.7 converges almost as efficiently as the equivalent linear case.

1. A method for analysing input data using a processor, wherein the input data comprises, for each set of physical entities, attribute values representing attributes of the respective physical entity and an outcome value representing an observed outcome for the respective physical entity, the analysis generates a model for predicting an outcome value for a further physical entity based on input data comprising attribute values associated with the further physical entity, the method comprising:
receiving, by the processor, the input data and storing the input data in an electronic data storage;
retrieving, by the processor, the input data from the data storage and processing the input data using a statistical modelling method to generate the model based on the input data;
calculating, by the processor, a case deleted estimate of the outcome value for each set of physical entities;
calculating, by the processor, a measure of deviance of the case deleted estimates from the outcome values of the input data; and
outputting, by the processor, the measure of deviance to the data storage for retrieval by a user.

2. The method of claim 1, further comprising
calculating a number and location of knots to include in the model to minimise the measure of deviance.

3. The method of claim 1, further comprising
identifying at least one attribute to omit from the model based on an associated deviance measure of the at least one attribute; and
removing the at least one attribute from the model.

4. A method for analysing input data using a processor, wherein the input data comprises, for each set of physical entities, attribute values representing attributes of the respective physical entity and an outcome value representing an observed outcome for the respective physical entity, the analysis generates a model for predicting an outcome value for a further physical entity based on input data comprising attribute values associated with the further physical entity, the method comprising:
receiving, by the processor, the input data;
processing the input data, by the processor, using a statistical modelling method to generate an intermediate model based on the input data, the intermediate model comprising parameter estimates and a variance/covariance matrix;
calculating, by the processor, a case deleted estimate of the outcome value for each set of physical entities based on the intermediate model; and
generating, by the processor, a noise reduced model comprising noise reduced parameters, a noise reduced variance/covariance matrix, and noise reduced case deleted estimates using an iterative process to minimise a measure of deviance of the noise reduced case deleted estimates from the outcome values of the input data.

5. The method of claim 4, wherein generating a noise reduced model further comprises replacing parameters βⱼ in the noise reduced model by noise reduced parameters β*ⱼ, with the noise reduced variances
$$Var ( {β}_{j}^{*} ) = {( \frac{{β}_{j}^{*}}{{β}_{j}} )}^{2} Var ( {β}_{j} ) ,$$
the noise reduced covariances
$$Cov ( {β}_{j}^{*} , {β}_{k}^{*} ) = ( \frac{{β}_{j}^{*}}{{β}_{j}} \frac{{β}_{k}^{*}}{{β}_{k}} ) Cov ( {β}_{j} , {β}_{k} ) ,$$
and the noise reduced case deleted linear predictors
$${η}_{( i )}^{*} = {η}_{i}^{*} - ( \frac{{h}_{i}^{*}}{1 - {h}_{i}^{*}} ) {g}^{′} ( {μ}_{i} ) ( {y}_{i} - {μ}_{i} ) where$$
$${h}_{i}^{*} = {\sum }_{jk} \frac{{X}_{ij} {β}_{j}^{*} {C}_{jk} {X}_{ik} {β}_{k}^{*} {W}_{i}}{{β}_{j} {β}_{k}}$$
$$and \frac{\partial {η}_{i}}{\partial {μ}_{i}} = {g}^{′} ( {μ}_{i} ) .$$

6. The method of claim 4, further comprising calculating a number and location of knots to include in the noise reduced model to minimise the measure of deviance.

7. The method of claim 4, further comprising
identifying at least one attribute to omit from the noise reduced model based on a measure of deviance of the at least one attribute relative to the noise reduced model; and
removing the at least one attribute from the noise reduced model.

8. The method of claim 4, wherein calculating a case deleted estimate comprises, for each entity, calculating the case deleted estimate directly and without running the intermediate model for the entity on the basis of the input data with the data associated with the entity omitted.

9. The method of claim 4, wherein the case deleted estimates are calculated directly for each entity by calculating case deleted linear predictors and deriving the case deleted estimates therefrom using an inverse link function.

10. The method of claim 9, wherein, for each entity, the case deleted linear predictor is calculated by adjusting a linear predictor provided by the intermediate model by subtracting an amount corresponding to an influence on the model caused by the outcome value for the entity.

11. The method of claim 10, wherein the influence on the model caused by the outcome value for an entity is calculated by multiplying a distance from the model to the respective outcome value by an influence factor and by a rate of change of the linear predictor by the estimate.

12. The method of claim 8, wherein calculating a case deleted estimate comprises calculating case deleted linear predictors η₍ᵢ₎ such that:
$${η}_{( i )} = {η}_{i} - ( \frac{{h}_{i}}{1 - {h}_{i}} ) {g}^{′} ( {μ}_{i} ) ( {y}_{i} - {μ}_{i} ) where {h}_{i} = {\sum }_{jk} {X}_{ij} {C}_{jk} {X}_{ik} {W}_{i}$$
$$and \frac{\partial {η}_{i}}{\partial {μ}_{i}} = {g}^{′} ( {μ}_{i} ) .$$

13. The method of claim 4, wherein calculating a case deleted estimate comprises calculating, for each entity, a case deleted estimate by running the intermediate model based on the input data with the attribute values associated with the entity omitted to generate a respective set of case deleted model parameters.

14. The method of claim 4, wherein the statistical modelling method generates a Generalised Linear Model.

15. The method of claim 4, wherein the statistical modelling method generates a Generalised Non-linear Model.

16. The method of claim 1, wherein the statistical modelling method generates a Generalised Linear Model.

17. The method of claim 1, wherein the statistical modelling method generates a Generalised Non-linear Model.

18. A computer-readable medium that stores computer-readable instructions thereon that, when executed by a processor, direct the processor to perform a method for analysing input data, wherein the input data comprises, for each set of physical entities, attribute values representing attributes of the respective physical entity and an outcome value representing an observed outcome for the respective physical entity, the analysis generates a model for predicting an outcome value for a further physical entity based on input data comprising attribute values associated with the further physical entity, the method comprising:
processing, by the processor, the input data using a statistical modelling method to generate the model based on the input data;
calculating, by the processor, a case deleted estimate of the outcome value for each set of physical entities;
calculating, by the processor, a measure of deviance of the case deleted estimates from the outcome values of the input data; and
outputting, by the processor, the measure of deviance.

19. A computer-readable medium that stores computer-readable instructions thereon that, when executed by a processor, direct the processor to perform a method for analysing input data, wherein the input data comprises, for each set of physical entities, attribute values representing attributes of the respective physical entity and an outcome value representing an observed outcome for the respective physical entity, the analysis generates a model for predicting an outcome value for a further physical entity based on input data comprising attribute values associated with the further physical entity, the method comprising:
processing, by the processor, the input data using a statistical modelling method to generate an intermediate model based on the input data, the intermediate model comprising parameter estimates and a variance/covariance matrix;
calculating, by the processor, a case deleted estimate of the outcome value for each set of physical entities based on the intermediate model; and
generating, by the processor, a noise reduced model comprising noise reduced parameters, a noise reduced variance/covariance matrix, and noise reduced case deleted estimates using an iterative process to minimise a measure of deviance of the noise reduced case deleted estimates from the outcome values of the input data.
